(19) United States
(12) Patent Application Publication
(10) Pub. No.: US 2026/0094533 A1
(43) Pub. Date: Apr. 2, 2026

(54) AUTONOMOUS EDUCATION SYSTEM AND METHOD

(71) Applicant: MASSON AI LLC, Windermere, FL (US)

(72) Inventor: Kyle A. Masson, Windermere, FL (US)

(21) Appl. No.: 19/335,953

(22) Filed: Sep. 22, 2025

Related U.S. Application Data
(60) Provisional application No. 63/702,263, filed on Oct. 2, 2024.

(51) Int. Cl. G09B 7/00; G06Q 10/0639; G06T 13/40

(52) U.S. Cl. CPC G09B 7/00; G06Q 10/06398; G06T 13/40

(57) ABSTRACT

A system for providing autonomous education is described. The system includes deep learning layers implemented by at least one processor. The deep learning layers include an artificial intelligence (AI) layer, an AI agent layer, and a generative AI layer. The AI layer commences an educational session and determines a learner profile and a context associated with the educational session. The AI agent layer determines an educational framework and an education delivery sequence corresponding to the determined learner profile, educational framework, and context. The generative AI layer generates immersive educational content based on the determined context and education delivery sequence. The generative AI layer renders, via an output device, the generated immersive educational content during the educational session. The generative AI layer also determines at least one session event during the educational session, modifies the immersive educational content based on the determined session event(s), and renders the modified immersive educational content.

### CROSS-REFERENCE TO RELATED APPLICATIONS

The present application claims priority under 35 U.S.C. § 119(e) to U.S. Provisional Patent Application No. 63/702,263, titled “System and Method for Blockchain-Based Education System” filed Oct. 2, 2024, the disclosure of which is herein incorporated by reference in its entirety.

### BACKGROUND OF THE INVENTION

Typically, education is governed by standardized curricula that assume uniform learning needs, interests, and abilities of learners. Such assumptions result in learners, including those requiring specialized instructions, alternative pacing, or vocational training, or those with disabilities or exceptional abilities, struggling to adapt to conventional teaching methods and environments. Consequently, capabilities of such learners tend to be underdeveloped, and an ability of such learners to learn, excel, and contribute remain unrealized.

More recently, efforts have been made to leverage digital/online platforms to address such deficiencies in the conventional teaching methods and environments. However, personalization provided by such digital platforms also tends to be limited, in that, standardized content is generally imparted through such mediums without taking into consideration individual learning styles, preferences, or skill levels. Further, such digital/online platforms often tend to have insufficient accessibility features, thereby hindering the learners, for example, with the disabilities or the exceptional abilities, from engaging with available educational resources completely. Furthermore, existing educational platforms operate as applications within traditional operating systems, creating additional layers of complexity, security vulnerabilities, and resource inefficiencies. Such implementations are limited by the underlying operating system's constraints and cannot fully optimize hardware resources for educational delivery.

In addition, administrative processes associated with education, such as those involving manual tasks including, but not limited to, record-keeping, grading, compliance reporting, and credential management, also pose barriers to educational efficiency, in that, such manual tasks consume significant time and resources. Integrating external services authorized to handle sensitive administrative data raise concerns related to security, privacy, and consistent enforcement of data protection standards.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates an exemplary environment including a system for providing autonomous education, in accordance with which various embodiments of the present disclosure are implemented;

FIG. 2 illustrates a schematic block diagram of an artificial intelligence (AI) model employed within at least one user device, at least one server, and/or at least one robot employed within the environment of FIG. 1, in accordance with some embodiments;

FIG. 3 illustrates a schematic block diagram of an exemplary user device employed within the environment of FIG. 1 and configured to implement one or more deep learning layers of the AI model of FIG. 2, in accordance with some embodiments;

FIG. 4 illustrates a schematic block diagram of an exemplary server employed in the environment of FIG. 1 and configured to implement one or more deep learning layers the AI model of FIG. 2, in accordance with some embodiments;

FIG. 5 illustrates a block diagram of an exemplary robot employed in the environment of FIG. 1 and configured to implement one or more deep learning layers the AI model of FIG. 2, in accordance with some embodiments;

FIG. 6 illustrates a block diagram of an exemplary input device, Internet-of-Things (IoT) device, and/or output device employed in the environment of FIG. 1, in accordance with some embodiments; and

FIG. 7 illustrates a method for providing the autonomous education via the system of FIG. 2 implemented by the user device of FIG. 3, the server of FIG. 4 and/or the robot of FIG. 5, in accordance with some embodiments.

Skilled artisans will appreciate that elements in the figures are illustrated for simplicity and clarity and have not necessarily been drawn to scale. For example, the dimensions of some of the elements in the figures can be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the description with details that will be readily apparent to those of ordinary skill in the art having the benefit of the description herein.

### DETAILED DESCRIPTION OF THE INVENTION

In one aspect, a system for providing autonomous education is described. The system includes at least one input device, at least one output device, at least one user device communicatively coupled with the at least one input device and the at least one output device, and a server in communication with the at least one user device. The at least one user device includes a user device processor and a user device memory for storing instructions and at least one user device artificial intelligence (AI) model, that when executed by the user device processor, causes the at least one user device to commence at least one educational session. The at least one user device is also configured to determine, via the at least one input device, a learner profile and a context associated with each educational session of the at least one educational session. Further, the at least one user device is configured to determine at least one educational framework associated with the determined context and the determined learner profile. The at least one user device is also configured to determine an education delivery sequence corresponding to the at least one determined educational framework and the determined context. In addition, the at least one user device is configured to provide, via a user device transceiver of the at least one user device, the determined context, the determined learner profile, the determined education delivery sequence to the server. The server includes a server processor and a server memory for storing instructions and at least one server artificial intelligence (AI) model, that when executed by the server processor, causes the server to generate at least one immersive educational content associated with the determined context based on the determined education delivery sequence for the at least one educational session. The server is also configured to provide the at least one generated immersive educational content to the at least one output device. The at least one output device is configured to provide the at least one immersive educational content received from the server corresponding to the at least one commenced educational session. The at least one input device is configured to determine at least one session event during the at least one commenced educational session. The at least one input device is also configured to provide the at least one determined session event to the server. The server is configured to modify the at least one generated immersive educational content based on the at least one determined session event and provide the at least one modified immersive educational content to the at least output device. The at least one output device is configured to adaptively modify the at least one provided immersive educational content and provide the at least one modified immersive educational content received from the server during the at least one commenced educational session.

In another aspect, an electronic device for providing autonomous education is described. The electronic device includes a processor and a memory for storing instructions and at least one user device artificial intelligence (AI) model, that when executed by the processor, causes the electronic device to commence, via the processor, at least one educational session. The electronic device is also configured to determine, via at least one input device, a learner profile and a context associated with each educational session of the at least one educational session. Further, the electronic device is configured to determine, via the processor, at least one educational framework associated with the determined context and the determined learner profile. The electronic device is also configured to determine, via the processor, an education delivery sequence corresponding to the at least one determined educational framework and the determined context. In addition, the electronic device is configured to generate, via the processor, at least one immersive educational content associated with the determined context based on the determined education delivery sequence for the at least one educational session. Furthermore, the electronic device is configured to provide the at least one generated immersive educational content. The electronic device is also configured to determine, via the at least one input device and the processor, at least one session event corresponding to the at least one provided immersive educational content during the at least one commenced educational session. Further, the electronic device is also configured to modify, via the processor, the at least one generated immersive educational content based on the at least one determined session event. In addition, the electronic device is configured to provide the at least one modified immersive educational content by adaptively modifying the at least one provided immersive educational content during the at least one commenced educational session

In yet another aspect, a method for providing autonomous education is described. The method includes commencing, via at least one user device, at least one educational session. The method also includes determining, via the at least one user device, a learner profile and a context associated with each educational session of the at least one educational session. Further, the method includes determining, via the at least one user device, at least one educational framework associated with the determined context. The method also includes determining, via the at least one user device, an education delivery sequence corresponding to the at least one determined educational framework and the determined context. In addition, the method includes providing, by the at least one user device, the determined context, the determined learner profile, the determined education delivery sequence to a server. Further, the method includes generating, via the server, at least one immersive educational content associated with the determined context based on the determined education delivery sequence for the at least one educational session. The method also includes providing, by the server, the at least one generated immersive educational content to the at least one user device corresponding to the at least one commenced educational session. Furthermore, the method includes determining, via at least one input device, the at least one user device, or a combination thereof, at least one session event during the at least one educational session. The method also includes providing, by the at least one user device, the at least one determined session event to the server. Further, the method includes adaptively modifying, by the server, the at least one generated immersive educational content based on the at least one determined session event. In addition, the method includes providing, by the server, the at least one modified immersive educational content to the at least one user device. The method also includes providing, via the at least one user device, the at least one modified immersive educational content.

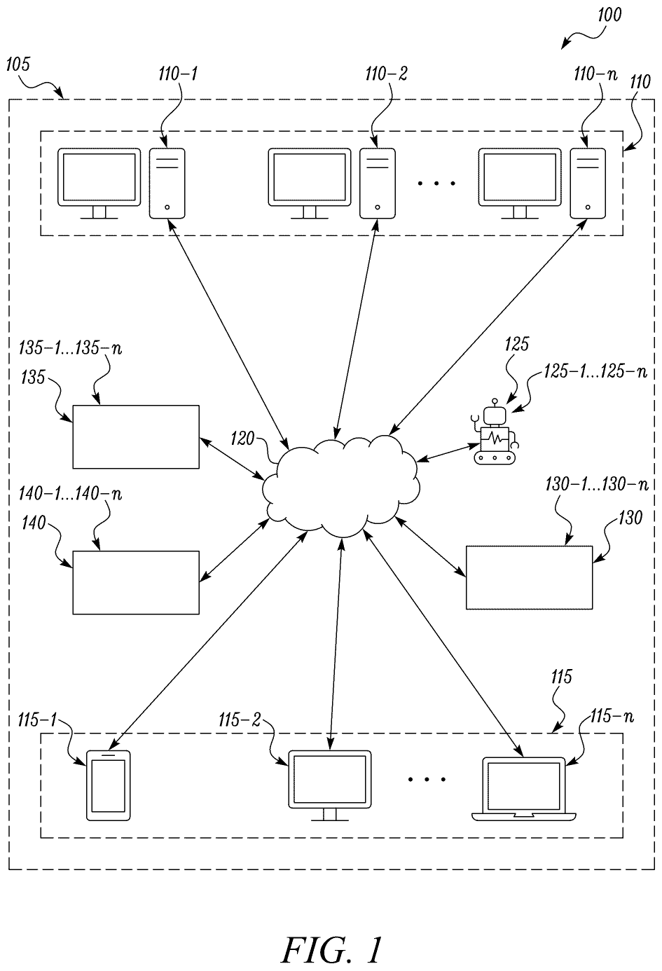

Referring to FIG. 1, an exemplary environment 100 including one or more servers, for example, 110-1, 110-2 . . . 110-n, referred to herein as ‘server(s) 110’ and/or one or more user devices, for example, 115-1, 115-2 . . . 115-n, referred to herein as ‘user device(s) 115’ is illustrated. The server(s) 110 is in communication with the user device(s) 115 via a network 120. Examples of the server(s) 110 and/or the user device(s) 115 include, but are not limited to, computers, laptops, mobile devices, handheld devices, personal digital assistants (PDAs), tablet personal computers, digital notebook, wearables, and other electronic devices now known or in future developed. Examples of the network 120 include, but are not limited to, a Local Area Network (LAN), a Wireless Local Area Network (WLAN), a Wireless Personal Area Network (WPAN), a Small Area Network (SAN), a telecommunication network including, but not limited to, a fourth generation (4G) and a fifth generation (5G) cellular network, and other wireless communication networks employing infra-red beams/signals, radio frequency (RF) signals, or other forms of wireless communication, and utilizing any of a variety of communications protocols, as is now known or in the future developed. In some embodiments, the system 105 also includes one or more robots or robotic devices, for example, 125-1 . . . 125-n, herein referred to as the ‘robot(s) 125’ and/or one or more Internet-Of-Things (IoT) devices, for example, 130-1 . . . 130-n, herein referred to as the ‘IoT device(s) 130’ in communication with the server(s) 110 and/or the user device(s) 115 via the network 120. Examples of the robot(s) 125 include, but are not limited to, a humanoid robot, an autonomous machine, and an automotive vehicle such as a self-driving car, a bus, or any other conveyance, transportation, and/or electro-mechanical device configured for steering, propulsion, voice communication, image/video display or projection, and/or providing haptic feedback. Examples of the IoT device(s) 130 include, but are not limited to, smart speakers, smart display units, health trackers, smartwatches, and other such inter-connected devices. In some embodiments, the system 105 also includes one or more input devices, for example, 135-1 . . . 135-n, herein referred to as the ‘input device(s) 135’, in communication with the server(s) 110 and/or the user device(s) 115 via the network 120. Examples of the input device(s) 135 include, but are not limited to, a microphone, a camera, a keyboard, a joystick, or any other device configured to capture an audio, a video, or an audio-visual data and provide the captured data to the server(s) 110 and/or the user device(s) 115. It will be apparent to those with ordinary skill in the art that the server(s) 110, the user device(s) 115, the robot(s) 125, and/or the IoT device(s) 130 are also configured to include one or more of the input device(s), for example, 135-1 . . . 135-n respectively. In some embodiments, the system 105 also includes one or more output devices, for example, 140-1 . . . 140-n, herein referred to as the ‘output device(s) 140’, in communication with the server(s) 110 and/or the user device(s) 115 via the network 120. Examples of the output device(s) 140 include, but are not limited to, displays, speakers, haptic output devices, one or more sensory output devices, or any other device configured to provide at least one immersive educational content in one or more visual, auditory, and/or sensory output formats. It will be apparent to those with ordinary skill in the art that the server(s) 110, the user device(s) 115, the robot(s) 125, and/or the IoT device(s) 130 are also configured to include one or more of the output device(s), for example, 140-1 . . . 140-n respectively.

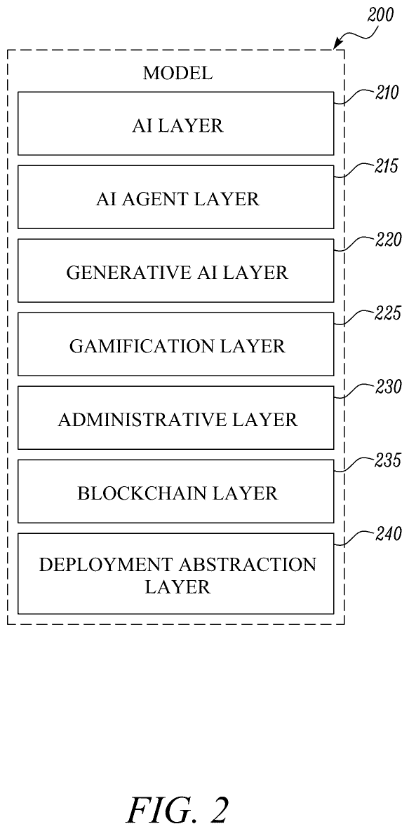

Referring to FIG. 2, a schematic block diagram of an exemplary artificial intelligence (AI) and/or deep learning model 200, herein referred to as the ‘model 200’ incorporated in the user device(s) 115, the server(s) 110, and/or the robot(s) 125 of the system 105 employed within the environment 100 of the FIG. 1 is illustrated. In some embodiments, the model 200 corresponds to a deep neural network (DNN) including a plurality of deep learning layers, for example, an AI layer 210, an AI agent layer 215, and a generative AI layer 220, a gamification layer 225, an administrative layer 230, a blockchain layer 235, and a deployment abstraction layer 240. Each layer of the plurality of deep learning layers, for example, 210 through 240 in the model 200 corresponds to a fundamental building block of a neural network capable of processing and transforming data as the data flows through different layers of the neural network. Each layer of the plurality of deep learning layers, for example, 210 through 240 performs specific functions, introducing non-linearity (non-linear relationship between input and output data) and/or abstraction (simplifying complex information and representing the data in a manageable and meaningful manner). In some embodiments, each layer of the plurality of deep learning layers, for example, 210 through 240 corresponds to a dense layer, a convolution layer, a recurrent layer, and/or a normalization layer. The dense layer is used for abstract representations of the input data, the convolutional layer is typically used for image analysis tasks, the pooling layer is used to reduce the size of data input, the recurrent layer is used for text processing with memory function, the normalization layer standardizes the output data from the one or more deep learning layers to minimize output variations between the plurality of deep learning layers.

In some embodiments, the model 200 and the plurality of deep learning layers, for example, 210 through 240 are included in a single electronic device, for example, the user device 115-1, the server, 110-1, or the robot 125-1. In some embodiments, the model 200 and one or more deep learning layers of the plurality of deep learning layers, for example, 210 through 240 are included in a combination of electronic devices, for example, the server(s) 110, the user device(s) 115, the robot(s) 125, or any combination thereof. In some embodiments, a complexity and/or a processing requirement to implement each deep learning layer of the plurality of deep learning layers, for example, 210 through 240 is different. For example, the complexity and the processing requirement to implement the AI Layer 210 and the AI agent layer 215 are lesser in comparison to the complexity and the processing requirement to implement the generative AI Layer 220. In some embodiments, the model 100 and one or more deep learning layers of the plurality of deep learning layers, for example, 210 through 240 are included in the combination of electronic devices, for example, the user device(s) 115, the server(s) 110, and the robot(s) 125, or any combination thereof based on the complexity, the processing requirement, and/or a processing capability of the electronic devices, for example, the user device(s) 115, the server(s) 110, and/or the robot(s) 125. In some embodiments, the model 100 and one or more deep learning layers of the plurality of deep learning layers, for example, 210 through 240 are included in the combination of electronic devices, for example, the user device(s) 115, the server(s) 110, and the robot(s) 125, or any combination thereof based on user preferences.

In some embodiments, the model 200 and one or more of the plurality of deep learning layers, for example, 210 through 240 are deployed as a standalone software application installed within conventional operating systems provided in the user device(s) 115, server(s) 110, and/or robot(s) 125. As another example, in some embodiments, the model 200 and one or more of the plurality of deep learning layers, for example, 210 through 240 are deployed as part of or as a standalone operating system implemented and optimized for delivery of educational content. In such embodiments, the deployment of the model 200 as the standalone operating system provides direct hardware control, optimized resource management, and improved security features in comparison to conventional operating systems. For example, in such embodiments, the model 200 is implemented on specialized hardware, repurposed computing devices, and/or virtual machines to provide the direct hardware control. In such embodiments, hardware resources to implement the model 200 and operating system processes are managed independent of traditional operating systems. In such embodiments, the model 200 and/or one or more of the plurality of deep learning layers, for example, 210 through 240, interface directly with one or more hardware components including processor(s), memory subsystems, storage devices, network interfaces, and/or educational peripherals through dedicated kernel-level drivers. In such embodiments, the implementation of the model 200 and one or more of the plurality of deep learning layers, for example, 210 through 240 as part of or as the standalone operating system enables optimized resource allocation for educational content processing and real-time adaptation based on content and/or user monitoring via the input device(s) 135 (see FIG. 1). In such embodiments, the standalone operating system implements custom memory management algorithms optimized for educational content caching, predictive content loading, and real-time session event processing. In some embodiments, the model 200 and one or more of the plurality of deep learning layers, for example, 210 through 240 are also deployed in cloud-based, hybrid local and cloud-based, or edge-computing based environments. In some embodiments, the deployment abstraction layer 240 of the model 200 automatically determines a deployment configuration corresponding to the model 200 and/or the remaining deep learning layers, for example, 210 through 235, of the plurality of deep learning layers, a target environment. For example, the deployment abstraction layer 240 determines one or more processing capabilities of each device, for example, the server(s) 110, the user device(s) 115, the robot(s) 125 and/or complexities of one or more functions to be performed by each device. Further, the deployment abstraction layer 240 identifies one or more of the plurality of layers, for example, 210 through 215 to be executed within each device, for example, the server(s) 110, the user device(s) 115, the robot(s) 125 or one or more remaining layers, for example, 220 through 235, to be executed externally by other devices based on the determined processing capabilities and/or functional complexities. The deployment abstraction layer 240 then enables execution of the one or more identified layers, for example, within each device, for example, the user device(s) 115 and initiates execution of the one or more identified remaining layers, 220 through 235 via external devices, the server(s) 110) based on the identification. In some embodiments, the deployment abstraction layer 240 is optional and the model 200 includes only the layers, for example, 210 through 235.

In one example of an exemplary deployment configuration, the user device, for example, 115-1 of the user device(s) 115 is configured to include the model 200 and the deep learning layers, for example, the AI layer 210 and the AI agent layer 215 and optionally also include the generative AI layer 220, the gamification layer 225, the administrative layer 230, the blockchain layer 235, and the deployment abstraction layer 240. As another example, the server, for example, 110-1 of the server(s) 110 is configured to include the model 200 and the deep learning layers, for example, the generative AI layer 220, the gamification layer 225, the administrative layer 230, and the blockchain layer 235, and optionally include the AI layer 210, the AI agent layer 215, and the deployment abstraction layer 240. As yet another example, the robot, for example, 125-1 of the robot(s) 125 is configured to include the model 200 and the deep learning layers, for example, the AI layer 210 and the AI agent layer 215 and optionally include the generative AI layer 220, the gamification layer 225, the administrative layer 230, the blockchain layer 235, and the deployment abstraction layer 240. As is apparent from the examples cited herein, the user device(s) 115, the server(s) 110, the robot(s) 125, and/or the IoT device(s) 130 are configured to include one or more of the plurality of deep learning layers, for example, 210 through 240 and optionally include the other layers of the plurality of deep learning layers, for example, 210 through 240. Various components of and respective functions performed by the user device(s) 115, the server(s) 110, and the robot(s) 125 are described hereinafter. It will be understood by those with ordinary skill in the art that the user device(s) 115, the server(s) 110, and the robot(s) 125 are configured to perform similar functions based on the one or more of the plurality of deep learning layers, for example, 210 through 240 included in the user device(s) 115, the server(s) 110, and/or the robot(s) 125.

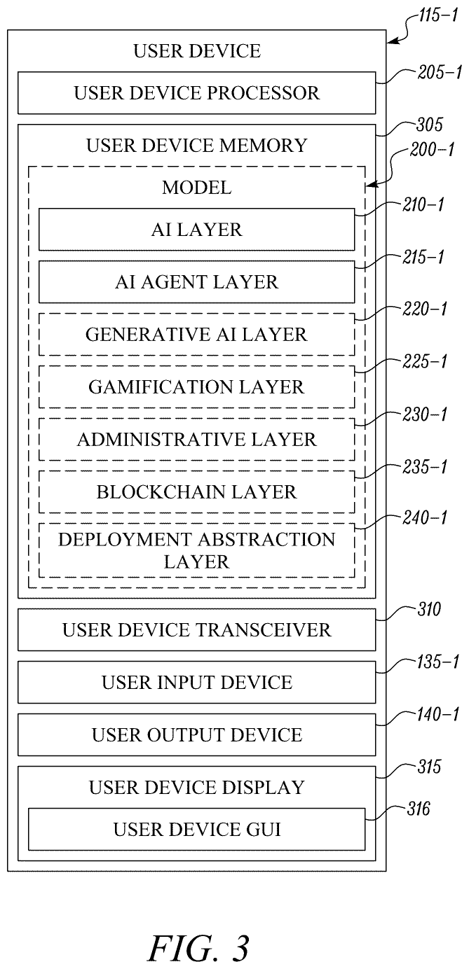

Referring to FIG. 3, various components of the user device 115-1 (see FIG. 1) are illustrated. It will be apparent to those with ordinary skill in the art that the remaining user devices, for example, 115-2 . . . 115-n are also configured to include similar components that perform corresponding functions as described hereinafter with respect to the components of the user device 115-1. The user device 115-1 includes, among other components, a processor 205-1, herein referred to as the ‘user device processor 205-1’, a user device memory 305, a user device transceiver 310, the input device 135-1, herein referred to as the ‘user input device 135-1’, and a user device display 315. In some embodiments, user device 115-1 additionally includes one or more user device output devices, for example, 140-1 including, but not limited to, a speaker, a haptic output, or any other output mechanism now known or in future developed that is integrated within or coupled to the user device 115-1. In some embodiments, the user device output device(s), for example, 140-1 is configured to provide at least one immersive educational content to one or more users. The components of the user device 115-1, including the user device processor 205-1, the user device memory 305, the user device transceiver 310, the user input device 135-1, the user device display 315, and the user device output device(s), for example, 140-1 cooperate with one another to enable operations of the user device 115-1. Each component communicates with one another via a user device local interface (not illustrated). The user device local interface includes, but not limited to, one or more buses or other wired or wireless connections, as is known in the art. The user device local interface includes additional elements, which are omitted for simplicity, such as controllers, buffers (caches), drivers, repeaters, and receivers, among many others, to enable communications. Further, the user device local interface includes address, control, and/or data connections to enable appropriate communications among the aforementioned components. The user device local interface further includes a serial port, a parallel port, an infrared (IR) interface, a universal serial bus (USB) interface and/or any other interface herein known or developed in the future.

The user input device 135-1 is configured to communicate information and command selections to the user device processor 205-1. Examples of the user input device 135-1 include, but are not limited to, a keyboard, a touch screen display (such as, the user device display 315), a camera, a touch pad, a microphone, a recorder, a mouse or any other user input mechanism now known or developed in the future. It will be understood by those with ordinary skill in the art that although the user input device 135-1 is illustrated as a single device, the user device 115-1 is configured to include multiple input devices. In some embodiments, the user input device 135-1 also includes one or more sensors (not shown). Examples of the sensor(s) include, but are not limited to, motion sensors such as, but not limited to, accelerometers and gyroscopes, environmental sensors such as, but not limited to, ambient light and temperature sensors, and position sensors such as, but not limited to, GPS and magnetometers. In some embodiments, the user input device 135-1 also corresponds to one or more peripheral input devices capable of being paired with the user device 115-1 via the network 120 (see FIG. 1), for example, a wireless network including, but not limited to, a Bluetooth, Wi-Fi, or a Wi-Fi direct network, or as a wired network or hardware connection such as, but not limited to, a USB peripheral to the user device 115-1. Examples of the peripheral input devices include, but are not limited to, a joystick, a gamepad, a keyboard, a mouse, a gesture-controlled device, or a wearable device such as, for example, a smart watch.

The user device transceiver 310 is configured to transmit data and/or signals to and receive data and/or signals from one or more other components of the server(s) 110 (see FIG. 1), the robots(s) 125 (see FIG. 1), and/or the IoT device(s) 130 (see FIG. 1). For example, the user device transceiver 310 is configured to transmit input data captured from the user input device 135-1 to the server(s) 110, the robots(s) 125, and/or the IoT device(s) 130 and similarly, receive the input from the server(s) 110, the robots(s) 125, and/or the IoT device(s) 130. The user device transceiver 310 includes a transmitter circuitry and a receiver circuitry to enable the user device 115-1 to communicate with the one or more other components. In this regard, the transmitter circuitry includes appropriate circuitry to transmit the one or more signals to the one or more other components and the receiver circuitry includes appropriate circuitry to receive the one or more signals from the one or more other components. It will be appreciated by those of ordinary skill in the art that the user device 115-1 includes a single user device transceiver 310 as illustrated or alternatively separate transmitting and receiving components, for example but not limited to, a transmitter, a transmitting antenna, a receiver, and a receiving antenna.

The user device display 315 is configured to display text, images, videos, numbers, infographics, charts, diagrams, motion graphics, typography, dialogue boxes, window, web forms, text input field, microphone button, camera button, file upload button, text output display window, audio player, image/video display window, and other graphical elements now known or developed in future. The user device display 315 includes a display screen or a computer monitor or any other display mechanism now known or in the future developed. Examples of the user device display 315 include, but are not limited to, a light emitting diode (LED) display and a liquid crystal display (LCD) display. In accordance with some embodiments, the user device display 315 is configured to display at least one immersive educational content on a user device graphical user interface (GUI) 316 of the user device display 315. In some embodiments, the user device GUI 316 corresponds to an application or a web portal or any other suitable interface for accessing the immersive educational content(s). The user device GUI 316 includes one or more graphical elements including, but not limited to one or more of dialogue boxes, window, web forms, text input field, microphone button, camera button, file upload button, text output display window, audio player, image/video display window, animation display window, virtual or augmented reality display window and/or the like.

The user device memory 305 is a non-transitory memory configured to store a set of instructions that are executable by the user device processor 205-1 to perform predetermined operations. For example, the user device memory 305 includes any of the volatile memory elements (for example, random access memory (RAM)), non-volatile memory elements (for example, read only memory (ROM)), and combinations thereof. Moreover, the user device memory 305 incorporates electronic, magnetic, optical, and/or other types of the non-transitory storage media. In accordance with various embodiments, the user device memory 305, for example, is configured to store a learner profile of a user, at least one educational framework associated with the user, a unique session identifier generated corresponding to each educational session, an education delivery sequence corresponding to the at least one determined educational framework, a hierarchy of educational elements in the education delivery sequence, at least one immersive educational content generated, modified, and/or gamified corresponding to each educational element in the education delivery sequence, one or more session events determined during one or more educational sessions, one or more assessment tests generated corresponding to each learner profile, a user performance recorded corresponding to the one or more assessment tests, an evaluation of the user performance, registration details of the user and/or the user device 115-1 and/or the user devices, for example, 115-2 . . . 115-n, one or more timestamped educational records or credentials associated with the user, a composite of the timestamped educational record(s) or credential(s) associated with the user, environmental data, behavioral data, emotional data, and/or biometric data associated with a user, one or more recommendations, speed of content delivery, and/or difficulty level of the at least one immersive educational content. The user device memory 305, for example, is also configured to store the model 200 (see FIG. 2) and one or more deep learning layers, for example, the AI layer 210 (see FIG. 2), the AI agent layer 215 (see FIG. 2), of the plurality of the deep learning layers, for example, 210 through 240 (see FIG. 2) of the model 200. In some embodiments, user device memory 305 is also configured to optionally store one or more additional deep learning layers, for example, 220 through 240 (see FIG. 2) of the model 200. The model 200, the AI layer 210, the AI agent layer 215, the optionally included deep learning layers, for example, 220 through 240 included in the user device memory 305 are referred to herein as the “model 200-1”, the “AI layer 210-1”, the “AI agent layer 215-1”, the “generative AI layer 220-1”, the “gamification layer 225-1”, the “administrative layer 230-1”, the “blockchain layer 235-1”, and the “deployment abstraction layer 240-1” respectively.

The user device processor 205-1 is configured to execute the instructions stored in the user device memory 305 to perform different operations. The user device processor 205-1 includes one or more microprocessors, microcontrollers, DSPs (digital signal processors), state machines, logic circuitry, or any other device or devices that process information or signals based on operational or programming instructions. The user device processor 205-1 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The user device processor 205-1 is configured to cooperate with other components of the user device 115-1 and implement at least one deep learning layer, for example, 210-1 through 235-1 to perform the operations described hereinafter in the present disclosure.

In some embodiments, the user device processor 205-1 is configured to receive an input from via at least one input device including, but not limited to, the user input device 115-1, the robot, for example, 125-1, or the IoT device, for example, 130-1 to commence at least one educational session. In some embodiments, the user device processor 205-1 is configured to execute the model 200 in response to the received input. In some embodiments, the user device processor 205-1 is configured to process the AI layer 210-1 upon execution of the model 200 to commence at least one educational session. In some embodiments, the user device processor 205-1 is configured to assign the unique session identifier corresponding to each educational session of the at least one educational session prior to the commencement. In some embodiments, the user device 115-1 is configured to register and authenticate, via the AI layer 210-1 a user and one or more user devices, for example, the user device 115-1, the user device 115-2 operated by the user prior to the commencement of the at least one educational session. For example, the user device 115-1 is configured to display, via the AI layer 210, an authentication user interface (not shown) on the user device display 315, a prompt to the user to provide user registration credentials to commence the educational session(s). For instances when the user is yet to be registered and/or authorized to commence the educational session(s), the user device 115-1 is configured to provide, via the AI layer 210-1, a registration user interface (not shown) on the user device display 315 for the registration of the user. In accordance with various embodiments, the user corresponds to a student and/or any learner engaging with the system 105 via the user device(s) 115, for example, 115-1, 115-2, the server(s) 110, and/or the robot(s) 125. In some embodiments, the user device 115-1 is configured to receive, via the user input device 135-1, one or more user registration credentials via the registration user interface, and storing the received user registration credentials in the user device memory 305. In some embodiments, the user device 115-1 is configured to provide, via the AI layer 210-1 and the user device transceiver 310, the received user registration credentials via the registration user interface to the server(s) 110. As another example, for instances when the user is already registered and/or authorized to commence the educational session(s), the user device 115-1 is configured to receive, via the authentication user interface and the user input device 115-1, the user registration credentials and authenticate, via the AI layer 210-1, the user and/or the user device 115-1 based on the received user registration credentials and the stored user registration credentials. In some embodiments, the user device 115-1 is configured to provide, via the AI layer 210-1 and the user device transceiver 310, the received user registration credentials via the authentication user interface to the server(s) 110 for authentication and receiving a confirmation of the authentication from the server(s) 110 based on the user registration credentials stored in the server(s) 110. In some embodiments, the user device 115-1 is configured to authenticate, via the AI layer 210-1, the user and the user device 115-1 based on the at least one stored educational record associated with the user.

In some embodiments, upon the authentication of the user and/or the user device 115-1 and the user device 115-1 is configured to commence, via the AI layer 210-1, the at least one education session. It will be understood by those with ordinary skill in the art that, in some embodiments, the user device 115-1 is also configured to the commence, via the AI layer 210-1, multiple educational sessions on different or inter-related educational topics, subjects, lessons, or content and/or on independent graphical user interfaces respectively provided in different visual portions (not shown) of the user device display 315 simultaneously. Upon the commencement of the educational session(s), the user device 115-1 is configured to determine, via the AI layer 210-1, a learner profile of the user associated with the commenced educational session(s) and a context associated with each educational session of the educational session(s). The context corresponds to data or information that is used by the AI layer 210-1 of the model(s) 220 to define a scope and one or more parameters of a calculation or a process such that the model(s) 220 is able to interpret one or more received real-time inputs received from one or more devices including, but not limited to, the user device(s) 115, the input device(s) 135, the robot(s) 125, and/or the IoT device(s) 130 based on the defined scope and the defined parameters of the calculation or the process. Examples of the one or more real-time inputs include, but are not limited to, including, but not limited to, location data, and environmental or real-world data, audio and/or visual data, and movement related data associated with a current device, for example, the user device 115-1 providing the at least one commenced educational session, a current location of the current device and/or the user operating the current device. In some embodiments, the scope includes, but is not limited to, one or more individuals, for example the user or learner providing the real-time input(s), environments, for example, a dorm room, a library, a bedroom, in which the user is currently physically present, and/or any other factor that governs, influences, and/or is associated with the at least one commenced educational session. In some embodiments, the parameters include, but are not limited to, visual cues, face/object identification, gestures, keywords, identifiers, device outputs from the one or more devices, stored data associated with the user and/or the at least one commenced educational session in the user device memory 305, a communication pattern, tone, and/or pitch, or any other attribute, feature, or characteristic associated with the one or more real-time inputs received via the one or more devices, for example, the user device(s) 115, the input device(s) 135, the robot(s) 125, and/or the IoT device(s) 130. In some embodiments, the user device 115-1 is configured to determine, via AI layer 210-1, the learner profile based on the at least one stored educational record associated with the user. The learner profile of the user includes, but is not limited to, an age, an educational level or credential, one or more interests, one or more skills, and one or more preferences of the user. In accordance with various embodiments, the user device 115-1 is also configured to determine, via AI layer 210-1, a context associated with each educational session of the educational session(s). In some embodiments, the user device 115-1 is configured to receive, via the user input device 135-1, one or more inputs including, but not limited to, voice inputs, touch inputs, gestures, and text or keyboard commands and determines the context associated with each educational session based on the received input(s). For example, the user device 115-1 is configured to receive, via the user input device 135-1, the voice and/or camera or gesture input of the user requesting for the educational session associated with the subject ‘mathematics’. Based on the received voice and/or camera input, the user device 115-1 is configured to determine, via the AI layer 210-1, the learner profile of user and the context of the requested educational session. The user device 115-1 is also configured to determine, via the AI layer 210-1, that the age of the user as 11, the educational level or credential of the user to be ‘Grade 5’ based on the stored educational and/or user registered credentials and that the context of the educational session corresponds to the subject ‘mathematics’. It will be understood by those with ordinary skill in the art that the user device 115-1 is configured to implement, via the AI layer 210-1, one or more Natural Language Processing (NLP) algorithms to process voice and/or video inputs and determine the context associated with each educational session based on the processing of the voice and/or video inputs.

In accordance with various embodiments, the user device 115-1 is configured to determine, via the AI agent layer 215-1, at least one educational framework associated with the determined context and the determined learner profile. The educational framework corresponds to a type of an educational approach and/or an education syllabus established by one or more national or international educational boards including, but not limited to, International Baccalaureate (IB), Cambridge International Examinations (CIE), Montessori, and International General Certificate of Secondary Education (IGCSE). In accordance with various embodiments, the user device 115-1 is also configured to determine, via the AI agent layer 215-1, an education delivery sequence corresponding to the at least one determined educational framework and the determined context. The education delivery sequence includes a hierarchy of educational elements associated with the determined context and is based on the at least one predefined education framework. In some embodiments, the educational elements correspond to, but are not limited to, a step-by-step or guided educational course or a series of lessons, chapters, and/or courses including one or more hierarchical sub-sections, sub-topics, and/or sub-chapters predefined for the user based on the determined learner profile and/or the determined context. For example, when the determined educational framework corresponds to International Baccalaureate (IB), the determined learner profile includes the age of the user as 11, the educational level or credential of the user to be ‘Grade 5’, and the determined context corresponds to the subject ‘mathematics’, the educational elements includes one or more topics including, but not limited to, “number and operations”, “geometry”, “measurement”, “data and statistics”, “money”, “word problems”, and “patterns/algebra/functions” and one or more sub-topics including, but not limited to, “place value”, “shapes”, “fractions”, “decimals”, and “exploring the coordinate plane”. In some embodiments, the user device 115-1 is configured to determine, via the AI agent layer 215-1, at least one educational element in the determined education delivery sequence to be provided to the user, via the user device display 315. In some embodiments, the user device 115-1 is also configured to determine, via the AI agent layer 215-1, the at least one educational element to be provided based on at least one previously presented educational element in the determined education delivery sequence to the user device 115-1 prior to the commencement of the current educational session. For example, the user device 115-1 is configured to determine, via AI agent layer 215-1, that the educational element corresponding to the topic “geometry” and the sub-topic “shapes” is to be provided to the user based on the previously presented educational element corresponding to the topic “number and operations” and the sub-topic “place value”. In some embodiments, the user device 115-1 is configured to present, via the AI agent layer 215-1 and the user device display 315, the determined educational sequence associated with the determined educational framework and the determined educational elements associated with the determined context. In such embodiments, the user device 115-1 is configured to receive, via the user input device 135-1, a selection of at least one educational element from the presented educational elements on the user device display 315 and associating the selected educational element(s) as the determined educational element(s).

In some embodiments, the user device 115-1 is configured to provide, via the AI agent layer 215-1, the determined learner profile, the determined context, the determined educational framework, the determined education delivery sequence, and/or the determined educational element(s) to the server(s) 110. In such embodiments, in response, the server(s) 110 is configured to generate and provide at least one immersive educational content corresponding to each educational element of the determined educational element(s) to the user device 115-1 for the at least one commenced educational session. In some embodiments, the server(s) 110 is also configured to gamify the generated immersive educational content(s) and provide the generated gamified immersive educational content(s) corresponding to each educational element of the determined educational element(s) to the user device 115-1 for the at least one commenced educational session. It will be understood that the originally generated immersive educational content and/or the gamified immersive educational content will herein be referred to as “immersive educational content” for purposes of clarity. In such embodiments, the user device 115-1 is configured to receive, via the AI agent layer 215-1 and the user device transceiver 310, the at least one generated immersive educational content associated with the determined context and the determined educational element from the server(s) 110 and displays, via the user device display 315, the at least one received immersive educational content. Non-limiting examples of the generated, received, and/or displayed immersive educational content(s) include one or more interactive videos, graphics, interactive two-dimensional (2D) or three-dimensional (3D) animated avatars, holograms, virtual or augmented reality presentations designed to deliver the generated immersive educational content(s) associated with the determined educational element(s) to the user device display 315. In alternative embodiments in which the user device 115-1 optionally includes the generative AI layer 220-1 and/or the gamification layer 225-1, the user device 115-1 is configured to generate, via the generative AI layer 220-1, the immersive educational content(s) and/or gamify, via the gamification layer 225-1, the generated immersive educational content(s) and provide the generated and/or gamified immersive educational content(s) to the user device 115-1, via for example, the user device display 315 and/or the user output device(s) 140-1. In such alternate embodiments, the user device 115-1 is configured to generate the immersive educational content(s) and/or the gamify the generated immersive educational content(s) based on one or more data repositories stored in the user device memory 305 and/or one or more data sources including, but not limited to, the Internet, third-party servers, and application programming interfaces (APIs).

In some embodiments, the user device 115-1 is configured to receive, via the user input device 135-1, a registration request to register at least one second user device, for example, the user device 115-2 of the plurality of user devices, for example, 115-1 . . . 115-n operated by the user corresponding to the at least one commenced educational session based on the registrations details of the user device(s), for example, 115-2 stored in the user device memory 305. In some embodiments, the at least one second user device, for example, the user device 115-2 is in communication with the user device processor 205-1 via the user device transceiver 310. In response to the registration request, the user device 115-1 is configured to register at least one second user device, for example, the user device 115-2 corresponding to the at least one commenced educational session and provide the received immersive educational content(s) to the at least one second user device, for example, the user device 115-2 such that the immersive educational content(s) is synchronously displayed on the user device 115-1 and the second user device(s), for example, 115-2. In alternate embodiments, the user device 115-1 is configured to provide the received registration request to the server(s) 110 and the server(s) 110 is configured to provide the immersive educational content(s) to the at least one second user device, for example, the user device 115-2 such that the immersive educational content(s) is synchronously displayed on the user device 115-1 and the second user device(s), for example, 115-2. In such embodiments, the user device 115-1 is configured to assign, via the AI agent layer 215-1, a priority to the user device 115-1 and the second user device(s) (additionally registered user device(s)), for example, 115-2 for the rendering of the generated immersive educational content(s) corresponding to the commenced educational session(s) and/or or for receiving the input(s) via the input device(s), for example, 135-1 associated with the corresponding user devices, for example, 115-, 115-2. In some embodiments, the user device 115-1 is also configured receive, via the user input device 135-1, the priority to be assigned to the user device 115-1 and the second user device(s), for example, 115-2 based on a preference of the user.

In some embodiments, the user device 115-1 is configured to determine, via the AI layer 210-1, the context associated with the commenced educational session(s) based on at least one input received via the second user device(s), for example, 115-2 in the addition to the user device 115-1. In some embodiments, the user device 115-1 is also configured to render/display, via the AI agent layer 215-1, the generated and/or received immersive educational content(s) on the user device display 315 of the user device 115-1 and on a display (not shown) of the second user device(s), for example, 115-2 simultaneously in a synchronized manner. In some embodiments, the user device 115-1 is configured to determine, via the AI agent layer 215-1, a completion the at least one displayed immersive educational content and/or a progress of the determined education delivery sequence based on the determined completion. In such embodiments, the user device 115-1 is configured to record and store, via the AI agent layer 215-1, the completion of the displayed immersive educational content(s) in the user device memory 305. In such embodiments, the user device 115-1 is configured to modify, via the AI agent layer 215-1, the determined context and provide at least one subsequent immersive educational content corresponding to a subsequent educational element(s) in the determined predefined education sequence based on the previously recorded completion of the displayed immersive educational content(s) corresponding to the determined educational element(s) and the previously recorded progress of the determined education delivery sequence. In such embodiments, the user device 115-1 is configured to provide the subsequent immersive educational content(s) corresponding to the subsequent educational element based on the tracking and/or modified context and receiving the subsequent immersive educational content(s). In such embodiments, the user device 115-1 is also configured to provide, via the AI agent layer 215-1, the previously stored/recorded immersive educational content(s) in the user device memory 305 associated with the determined educational element(s) at any given point in time in response to a user request received via the user input device 135-1. In alternate embodiments in which the user device 115-1 optionally includes the generative AI layer 220-1, the user device 115-1 is configured to generate, via the generative AI layer 220-1, and display, via the user device display 315, the subsequent immersive educational content(s) corresponding to the subsequent educational element based on the tracking and/or modified context.

In some embodiments, the user device 115-1 is configured to continuously monitor or track, via the user input device 135-1 and IoT device(s) 130, the user, user behavior(s), and/or an environment (not shown) surrounding the user during the commenced educational sessions. In such embodiments, the user device 115-1 is configured to determine, via the AI agent layer 215-1 and the user input device 135-1, at least one session event during the commenced educational session(s). In such embodiments, the user device 115-1 is configured to receive, via the user device transceiver 310, the at least one session input associated with the at least one session event detected, via the IoT device(s) 130 employed within the environment 100, during the commenced educational session(s). In such embodiments, the IoT device(s) 130 are configured to be in communication with the user device processor 205-1 via the network 120. Further, in such embodiments, the IoT device(s) 130 are also configured to monitor the commenced educational session(s), detect the at least one session event, and provide the at least one session input associated with the at least one session event. In such embodiments, the user device 115-1 is configured to determine, via the AI agent layer 215-1, the user input device 135-1 and/or the IoT device(s) 130, real-time environmental data, behavioral data, emotional data, and/or biometric data associated with the user interacting with the displayed or rendered immersive educational content(s) during the commenced educational session(s) based on the monitoring or tracking. In accordance with various embodiments, the at least one determined session event corresponds to, but is not limited to, a change in the determined real-time environmental data, behavioral data, emotional data, and/or biometric data, associated with the user determined or detected during the commenced educational session(s). In accordance with some embodiments, the at least one determined session event also corresponds to, but is not limited to, at least one user input or user-initiated change received, via the user input device 135-1, corresponding to the displayed immersive educational content(s). In accordance with some embodiments, the at least one determined session event also corresponds to, but is not limited to, at least one user inputted annotation received, via the user input device 135-1, corresponding to the at least one rendered or displayed immersive educational content. For example, the user device 115-1 is configured to determine the session event corresponding to an increase in heart rate, blood pressure, or any other biometric parameters of the user via the sensor(s) provided in the user device 115-1 or via the second user device, for example, 115-2 including, but not limited to, a remote wireless user device such as a wearable device worn by the user. In another example, the user device 115-1 is configured to determine the session event corresponding to a reduced lighting around an area or an environment such as, for example, a room surrounding the user device 115-1 and/or the user. In yet another example, the user device 115-1 is configured to determine the session event corresponding to one or more user voice inputs, gestures, or expressions captured via the user input device 135-1, for example, a camera (not shown) and/or the IoT device(s) 130 (see FIG. 1) that indicate one or more emotional phases or behavioral patterns of the user during the commenced educational session(s). In yet another example, the user device 115-1 is configured to determine the session event corresponding to a user voice command or a text input indicative of a request to modify the displayed immersive educational content(s) or a request to provide immersive educational content(s) corresponding to another or a modified educational element. In accordance with various embodiments, the user device 115-1 is configured to modify, via the AI agent layer 215-1, the determined context of the commenced educational session(s) based on the determined session event(s).

In some embodiments, the user device 115-1 is configured to provide, via the AI agent layer 215-1, the determined session event(s) to the server(s) 110 via the user device transceiver 310. In such embodiments, in response, the server(s) 110 is configured to modify the previously generated immersive educational content(s) corresponding to each educational element of the determined educational element(s) and provide the modified generated immersive educational content(s) to the user device 115-1 during the commenced educational session(s) in real-time. In such embodiments, the server(s) 110 is also configured to modify a difficulty level of the modified immersive educational content(s) to be lesser or greater in comparison to the previously rendered immersive educational content(s). In such embodiments, the server(s) 110 is also configured to modify a response, a tone, an animation, and/or a presentation style of the 2D or 3D avatar based on the at least one determined session event. In such embodiments, the user device 115-1 is configured to receive, via the user device transceiver 310, the modified immersive educational content(s) associated with the determined context, the modified context, the determined educational element, and/or the modified educational element requested by the user from the server(s) 110. In such embodiments, the user device 115-1 is configured to adaptively modify a currently displayed immersive educational content(s) on the user device GUI 316 of the user device display 315 to display the modified immersive educational content(s) to the user based on the determined session event(s). In alternative embodiments in which the generative AI layer 220-1 is optionally included in the user device 115-1, the user device 115-1 is also configured to modify, via the generative AI layer 220-1, the immersive educational content(s), the difficulty level, the response, the tone, the animation, and/or the presentation style associated with the previously rendered immersive education content(s) based on the determined session event(s) and rendering the modified immersive educational content(s) on the user device display 315.

In embodiments involving the synchronous display of the immersive educational content(s) on the user device 115-1 and the second user device(s), for example, 115-2, the user device 115-1 is configured to receive, via the user input device 135-1 of the user device 115-1 and at least one input device (not shown) of the second user device(s), for example, 115-2, the session input(s) associated with the determined session event(s) based on the assigned priority. In accordance with various embodiments, the session input(s) include, but are not limited to, the real-time environmental data, the behavioral data, the emotional data, and/or the biometric data, associated with the user. In such embodiments, the user device 115-1 is configured to determine, via the AI agent layer 215-1, the session event(s) based on the received session input(s) from the input devices of both the user device 115-1 and the second user device(s), for example, 115-2. In such embodiments, the user device 115-1 is configured to merge, via the AI agent layer 215-1, the determined session event(s) corresponding to each user device, for example, 115-1 and 115-2. Further, in such embodiments, the user device 115-1 is configured to determine, via the AI agent layer 215-1, at least one overlap or conflict between the determined session event(s) corresponding to each user device, for example, 115-1 and 115-2. In such embodiments, the user device 115-1 is also configured to synchronize, via the AI agent layer 215-1, in real-time, the modified immersive educational content(s) displayed on each user device, for example, 115-1, 115-2 based on the at least one merged session event(s) and the determined overlap(s) or conflict(s). In some embodiments, the user device 115-1 is configured to adaptively render, via the AI agent layer 215-1, the modified immersive educational content(s) on the user devices, for example, 115-1, 115-2 during the commenced educational session(s) based on the assigned priority to the user device(s), for example, 115-1, 115-2.

In embodiments when the gamified educational immersive content(s) is rendered or displayed on the user device display 315, the user device 115-1 is configured to track and/or evaluate, via the AI agent layer 215-1 and/or the user input device 135-1, a user performance corresponding to the displayed gamified immersive educational content(s). In such embodiments, the user device 115-1 is configured to provide, via AI agent layer 215-1 and the user device display 315, a performance indication and/or a reward based on and associated with the tracked and/or evaluated user performance. In such embodiments, the user device 115-1 is configured to modify the determined context and/or determine the session event(s) corresponding to the user performance during the commenced educational session. In such embodiments, the user device 115-1 is configured to provide, via the AI agent layer 215-1 the tracked and/or evaluated user performance, the modified context, and/or the determined session event(s) to the server(s) 110 and the server(s) 110 are configured to modify the previously gamified immersive educational content(s) and provide the modified gamified immersive educational content(s) to the user device 115-1 via the network 120. In such embodiments, the user device 115-1 is configured to render or display the modified gamified immersive educational content(s) received from the server(s) 110 on the user device display 315 during the commenced educational session based on the tracked and/or evaluated user performance. In alternate embodiments in which the user device 115-1 optionally includes the gamification layer 225-1, the user device 115-1 is configured to modify, via the gamification layer 225-1, the gamification of the immersive educational content(s) and render the modified gamified immersive educational content(s) on the user device display 315 during the commenced educational session based on the tracked and/or evaluated user performance.

In some embodiments, the user device 115-1 is also configured to request and/or receive, via the AI agent layer 215-1, at least one assessment test associated with the rendered immersive educational content(s) generated and provided by the server(s). In some embodiments, the user device 115-1 is also configured to request and/or receive, via the AI agent layer 215-1, assessment test(s) during or after a completion of the displayed immersive educational content(s) and/or the modified immersive educational content(s) in the commenced educational session, or after a completion of a plurality of educational sessions corresponding to the plurality of educational elements in the determined predefined education sequence. In such embodiments, the user device 115-1 is also configured to provide, via the user device display 315, the received assessment test(s) to the user. In such embodiments, the user device 115-1 is also configured to record, via the user input device 135-1, a user performance corresponding to the provided assessment test(s). In such embodiments, the user device 115-1 is also configured to track, via the AI agent layer 215-1 and/or the user input device 135-1, a progress of and/or the user performance corresponding to the assessment test(s) provided during the commenced educational session. In such embodiments, the user device 115-1 is also configured to modify the determined context based on the tracking. In such embodiments, the user device 115-1 is also configured to determine the session event(s) associated with the user performance corresponding to the displayed assessment test(s) during the commenced educational session. In such embodiments, the user device 115-1 is also configured to provide the tracked progress and/or the user performance, the modified context, and/or the determined session event(s) corresponding to the provided assessment test(s) to the server(s) 110 via the network 120. In some embodiments, in response, the server(s) 110 is configured to modify the assessment test(s) generated corresponding to the predefined education element(s) and provide the modified assessment test(s) to the user device 115-1 via the network 120. In such embodiments, the user device 115-1 is configured to render, via the user device display 315, the modified assessment test(s) based on the tracked progress and/or the user performance, the modified context, and/or the determined session event(s). In alternate embodiments in the which the user device 115-1 optionally includes the generative AI layer 220-1, the user device 115-1 is configured to generate and/or modify the assessment test(s) generated corresponding to the predefined education element(s) and display, via the user device display 315, the generated and/or the modified assessment test(s) based on the tracked progress and/or the user performance, the modified context, and/or the determined session event(s). In such embodiments, a difficulty level of the modified assessment test(s) rendered on the user device display 315 is less than or greater than the previously rendered assessment test(s). In such alternate embodiments, the user device 115-1 is configured to generate, via the generative AI layer 220-1, the assessment test(s), based on the one or more data repositories stored in the user device memory 305 and/or the one or more data sources including, but not limited to, the Internet, third-party servers, and application programming interfaces (APIs).

In some embodiments, the user device 115-1 is configured to provide the tracked progress and/or the user performance corresponding to the assessment test(s) upon completion of the assessment test(s) to the server(s) 110 via the network 120. In such embodiments, the server(s) 110 is configured to verify a compliance of the assessment test(s) and/or the recorded user performance corresponding to the educational element(s) provided to the user device 115-1 with the determined educational framework(s). In such embodiments, the server(s) 110 is also configured to evaluate the recorded user performance based on the verification and at least one rule associated with the predefined education framework(s). In such embodiments, the server(s) 110 is also configured to update, the learner profile of the user based on verification and the evaluation. The updated learner profile includes user achievement data including, but is not limited to, one or more grades, levels, scores, rankings, and/or ratings attributed to the user based on the verification and the evaluation. In some embodiments, the server(s) 110 is configured to perform the verification, evaluation, and updating of the leaner profile via one or more third party servers (not shown) or APIs associated with one or more education governing entities.

In some embodiments, the user device 115-1 is configured to request and/or receive, via the user device transceiver 310, an updated learner profile, user educational record or credential, and/or user achievement data from the server(s) 110 based on the tracked, recorded, and/or evaluated user performance corresponding to the gamified immersive content(s) and/or the assessment test(s). In such embodiments, the user device 115-1 is configured to store the updated learner profile, the user educational record or credential, and/or the user achievement data in the user device memory 305. In such embodiments, the user device 115-1 is configured to commence, via the AI layer 210-1, a subsequent educational session based on the stored updated learner profile, the user educational record or credential, the user achievement data, tracked progress of the determined education sequence, and/or the recorded completion of the previously displayed immersive content(s) corresponding to the educational element(s). In some embodiments, the user device 115-1 is also configured to provide the tracked, recorded, and/or evaluated user performance on the user device display 315 to the user upon completion of the rendering of the gamified immersive content(s) and/or the assessment test(s) or in response to a user request received via the user input device 135-1. In accordance with various embodiments, the user device 115-1 is configured to receive, via the user input device 135-1, a permission or a revocation of a permission to access the at least one stored educational record or credential, the determined and/or updated learner profile, the user achievement data, the recorded, and/or evaluated user performance associated with the user by third-party entities. In such embodiments, the user device 115-1 is configured to provide, via the user device transceiver 310 and the network 120, the received permission or the revocation of the permission to the server(s) 110.

In accordance with various embodiments, the user device 115-1 is configured to determine a connectivity of the user device 115-1 to the network 120 during or prior to the commencement of the at least one educational session. In such embodiments, the user device 115-1 is configured to queue at least one action associated with the determined learner profile and/or the stored educational record or credential associated with the user when the determined connectivity is indicative of an unavailability of the network 120. In such embodiments, the user device 115-1 is also configured to initiate the at least one action when the determined connectivity is indicative of an availability of the network 120. The at least one action includes, but is not limited to, updating and/or modification of the determined learner profile, the stored educational record or credential, the displayed immersive educational content(s), the assessment test(s), recorded user performance, the tracked progress and/or completion of the displayed immersive educational content(s) corresponding to the educational element(s).

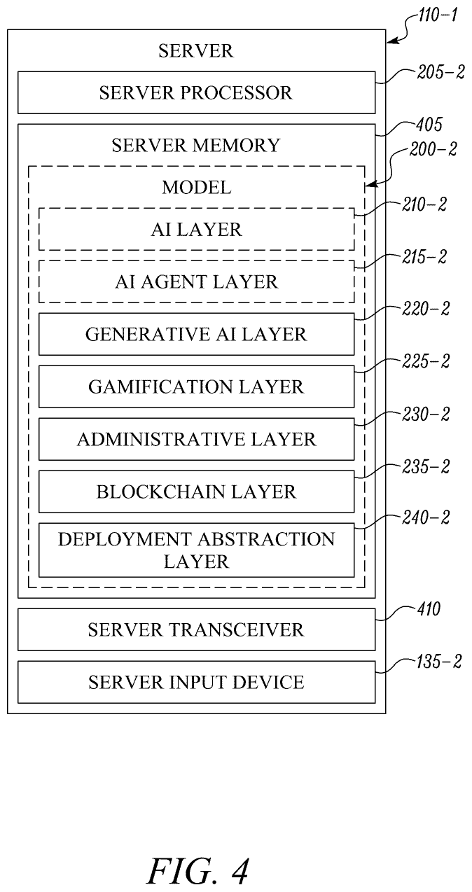

Referring to FIG. 4, various components of the server 110-1 (see FIG. 1) are illustrated. It will be apparent to those with ordinary skill in the art that the remaining servers for example, 110-2 . . . 110-n are also configured to include similar components that perform corresponding functions as described hereinafter with respect to the components of the server 110-1. The server 110-1 includes, among other components, the processor 205-2, herein referred to as the ‘server processor 205-2’, a server memory 405, a server transceiver 410, and the input device 135-2, herein referred to as the ‘server input device 135-2’. The components of the server 110-1, including the server processor 205-2, the server memory 405, and the server transceiver 410, cooperate with one another to enable operations of the server 110-1. Each component communicates with one another via a server local interface (not illustrated). The server local interface includes, but not limited to, one or more buses or other wired or wireless connections, as is known in the art. The server local interface includes additional elements, which are omitted for simplicity, such as controllers, buffers (caches), drivers, repeaters, and receivers, among many others, to enable communications. Further, the server local interface includes address, control, and/or data connections to enable appropriate communications among the aforementioned components.

The server transceiver 410 is configured to transmit data and/or signals to and receive data and/or signals from one or more other components of the user device(s) 115 (see FIG. 1), the robots(s) 125 (see FIG. 1), and/or the IoT device(s) 130 (see FIG. 1). For example, the server transceiver 410 is configured to receive input data captured by the user device(s) 115, the robots(s) 125, the IoT device(s) 130, and/or the input device(s) 135 and similarly, transmit the output data received from the server processor 205-2 to the user device(s) 115, the robots(s) 125, and/or the IoT device(s) 130. The server transceiver 410 includes a transmitter circuitry and a receiver circuitry to enable the server 110-1 to communicate with the one or more other components. In this regard, the transmitter circuitry includes appropriate circuitry to transmit the one or more signals to the one or more other components and the receiver circuitry includes appropriate circuitry to receive the one or more signals from the one or more other components. It will be appreciated by those of ordinary skill in the art that the server 110-1 includes a single server transceiver 410 as illustrated, or alternatively separate transmitting and receiving components, for example but not limited to, a transmitter, a transmitting antenna, a receiver, and a receiving antenna.

The server memory 405 is a non-transitory memory configured to store a set of instructions that are executable by the server processor 205-2 to perform predetermined operations. For example, the server memory 405 includes any of the volatile memory elements (for example, random access memory (RAM)), non-volatile memory elements (for example, read only memory (ROM)), and combinations thereof. Moreover, the user device memory 305 incorporates electronic, magnetic, optical, and/or other types of the non-transitory storage media. In accordance with various embodiments, the user device memory 305, for example, is configured to store a learner profile of a user at least one educational framework associated with the user, a session identifier generated corresponding to each educational session, an education delivery sequence corresponding to the at least one determined educational framework, a hierarchy of educational elements in the education delivery sequence, at least one immersive educational content generated, modified, and/or gamified corresponding to each educational element in the education delivery sequence, one or more session events determined during one or more educational sessions, one or more assessment tests generated corresponding to each learner profile, a user performance recorded corresponding to the one or more assessment tests, an evaluation of the user performance, registration details of the user and/or the user device(s) 115, one or more timestamped educational records or credentials associated with the user, a composite of the timestamped educational record(s) or credential(s) associated with the user, environmental data, behavioral data, emotional data, and/or biometric data associated with a user, one or more recommendations, speed of content delivery, and/or difficulty level of the at least one immersive educational content. In accordance with various embodiments, the server memory 405 is also configured to store the model 200 (see FIG. 2) and the deep learning layers 220 through 235 (see FIG. 2) of the plurality of the deep learning layers, for example, 210 through 240 (see FIG. 2) of the model 200. In some embodiments, the server memory 405 is also configured to optionally store the deep learning layers 210 (see FIGS. 2), 215 (see FIG. 2), and 240 (see FIG. 2) of the plurality of the deep learning layers, for example, 210 through 240 of the model 200. The model 200, the AI layer 210, the AI agent layer 215, the optionally included deep learning layers, for example, 220 through 240 included in the server memory 405 are referred to herein as the “model 200-2”, the “AI layer 210-2”, the “AI agent layer 215-2”, the “generative AI layer 220-2”, the “gamification layer 225-2”, the “administrative layer 230-2”, the “blockchain layer 235-2”, and the “deployment abstraction layer 240-2” respectively.

The server processor 205-2 is configured to execute the instructions stored in the server memory 405 to perform different operations. The server processor 205-2 includes one or more microprocessors, microcontrollers, DSPs (digital signal processors), state machines, logic circuitry, or any other device or devices that process information or signals based on operational or programming instructions. The server processor 205-2 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The server processor 205-2 is configured to cooperate with other components of the server 110-1 and/or implement the deep learning layers, for example, 210-2 through 235-2 to perform the operations described hereinafter.

It will be apparent to those with ordinary skill in the art that, in embodiments when the server memory 405 optionally includes the AI layer 210-2 and the AI agent layer 215-2, the server 110-1 is configured to execute the model 200-2 and perform the functions of the AI layer 210-2 and the AI agent layer 215-2 similar to the functions of the AI layer 210-1 (see FIG. 3) and the AI agent layer 215-1 (see FIG. 3) performed by the user device 115-1 (see FIG. 3). For example, the server 110-1 is configured to receive, via the AI layer 210-2, the user registration credentials to be registered and/or to be authenticated from one or more user devices, for example, 115-1, 115-2 (see FIG. 1) of the user device(s) 115 and/or the robot(s) 125, for example, 125-1 via the network 120. In response, the server 110-1 is configured to register and/or authenticate the user device(s) 115, the robot(s) 125 and/or the user based on the received user registration credentials and/or at least one stored educational record/credential and/or user registration credentials associated with the user. Further, in such embodiments, the server 110-1 is configured to commence, via the AI layer 210-2, the at least one educational session(s) via the user device(s) 115 or the robot(s) 125. In such embodiments, the server 110-1 is also configured to determine the learner profile associated with the user and the context associated with the commenced educational session(s) based on one or more inputs received from the user device(s) 115, the IoT device(s) 130, and/or the robot(s) 125 via the network 120. In such embodiments, the server 110-1 is also configured to determine, via the AI agent layer 215-2, the educational framework associated with the determined context and the determined learner profile. In such embodiments, the server 110-1 is also configured to determine, via the AI agent layer 215-2, the education delivery sequence corresponding to the at least one determined educational framework and the determined context. In such embodiments, the server 110-1 is also configured to determine, via the AI agent layer 215-2, the educational element(s) associated with the determined education delivery sequence. In alternate embodiments, the server 110-1 is configured to receive the determined learner profile, the determined context, the determined educational framework, the determined education delivery sequence, and/or the determined educational element(s) from each user device, for example, 115-1 of the user device(s) 115 and/or the robot(s) 125.

In some embodiments, the server 110-1 is configured to process the generative AI layer 220-2 stored in the server memory 405 based on the determined learner profile, the determined context, the determined educational framework, the determined education delivery sequence, and/or the determined educational element(s). In some embodiments, the server 110-1 is also configured to process the generative AI layer 220-2 upon receipt of the determined learner profile, the determined context, the determined educational framework, the determined education delivery sequence, and/or the determined educational element(s) from the user device(s) 115 and/or the robot(s) 125. In some embodiments, the server 110-1 is configured to determine, via the generative AI layer 220-2, the at least one immersive educational content to be generated corresponding to each educational element of the determined educational element(s) based on the determined learner profile, the determined context, the determined educational framework, the determined education delivery sequence, and/or the determined educational element(s), and the one or more real-time inputs received from the input device(s) 135, the IoT device(s) 130, the user device(s) 115 or the robot(s) 125. In some embodiments, the server 110-1 is configured to generate, via the generative AI layer 220-2, the at least one immersive educational content corresponding to each educational element of the determined educational element(s) based on the determination. The immersive educational content corresponds to content designed to provide one or more digital and/or sensory educational experiences to a learner such that the learner is able to actively engage with the content provided to the learner via one or more devices including, but not limited to, the user device 115 and/or other user device(s) 115 and/or the robot(s) 125, within a simulated or real environment in a manner that goes beyond interacting with traditional media. In some embodiments, the server(s) 110 is configured to implement one or more technological processes, methods and/or techniques associated with one or more technologies including, but not limited to, virtual reality (VR), augmented reality (AR), and extended reality (XR) technologies to generate the at least one immersive education content. In some embodiments, the server 110-1 is also configured to generate the at least one immersive educational content based on the one or more real-time inputs received from one or more data sources including, but not limited to, the user device(s) 115, the input device(s) 135, the IoT device(s) 130, and/or the robot(s) 125. Examples of the one or more real-time inputs include, but are not limited to, location data, environmental or real-world data, the audio and/or visual data, movement related data, and the determined context and/or contextual information associated with a current device, for example, the user device 115-1 providing the at least one commenced educational session, a current location of the current device and/or the user operating the current device. In some embodiments, the at least one generated immersive educational content also includes guided content generated and adapted to one or more operational environments and task requirements based on the one or more received real-time inputs. In some embodiments, the server 110-1 is also configured to integrate the real-world data received from the one or more data sources with one or more virtual learning elements including, but not limited to, avatars and 2D/3D virtual objects, and generate the at least one immersive educational content based on the integration. In some embodiments, the server 110-1 is configured to generate the at least one immersive educational content in one or more output formats and to include one or more experiential effects including, but not limited to, visual, auditory, haptic, olfactory, and thermal effects in one or more of the output formats.

In one example, the server 110-1 is configured to generate, via the generative AI layer 220-2, at least one spatial audio content as part of the at least one immersive educational content to provide and/or simulate a three-dimensional (3D) surround sound field or effect to a listener of the spatial audio content(s). In some embodiments, to generate the at least one spatial audio content, the server 110-1 is configured to implement, via the generative AI layer 220-2, one or more spatialization techniques including, but not limited to, generic or custom-trained head-related transfer functions (HRTFs), crosstalk-cancellation, amplitude/energy panning, beamforming, ambisonic encoding/decoding, wavefield-synthesis and/or other spatialization techniques now known or in future developed. In some embodiments, the server 110-1 is configured to generate the at least one spatial audio content(s) in one or more audio formats including, but are not limited to, binaural, transaural stereo, channel-based, object-based, ambisonics (including Ambisonics (HOA) and Higher-Order Stereophony (HOS)), and other spatial audio formats now known or in future developed. In some embodiments, the server 110-1 is also configured to determine, via the generative AI layer 220-2, sound-source positions, orientations, and trajectories for one or more educational elements including, but not limited to, a narrated 3D model, a speaking avatar, and/or a lab instrument included in the at least one immersive educational content and provide corresponding audio objects/components including, but not limited to, ambisonic components, channel beds, and/or one or more hybrid mixtures of audio that are positioned world-locked, scene-locked, head-locked, and/or device-locked relative to the learner and/or at least one portion of the at least one generated immersive educational content. The world-locked audio positioning corresponds to positioning the at least one spatial audio content fixedly in a physical space in Augmented Reality (AR) and/or Mixed Reality (MR) environments. The scene-locked audio positioning corresponds to positioning/providing at least one portion of the at least one spatial audio content corresponding to at least one portion of the at least one generated immersive educational content. The scene-locked audio positioning corresponds to positioning/providing the at least one spatial audio content fixedly in a single direction, irrespective of the listener's head movement. The device-locked audio positioning corresponds to positioning/providing each spatial audio content of the at least one spatial audio content to a specific device, for example, the user devices 115-1, 115-2 only.

In some embodiments the server 110-1 is configured to generate and provide one or more instructions to one or more of the IoT device(s) 130 to implement, via the generative AI Layer 220-2, one or more technologies, for example, the extended reality (XR) technology to coordinate one or more functions of one or more of the IoT device(s) with the at least one generated immersive educational content. The IoT device(s) 130 are, in turn, configured to provide one or more haptic and tactile learning experiences including, but not limited to, physical force feedback mechanisms and texture simulation to the user along with the at least one generated immersive content in a coordinated manner based on the one or more generated instructions received from the server 110-1. In some embodiments, the at least one generated immersive educational content also includes one or more virtual, augmented, and mixed reality presentations with real-time environmental integration based on the one or more real-time inputs received. In some embodiments, the at least one generated immersive educational content includes one or more collaborative learning features or experiences including, but not limited to, multi-user shared virtual and augmented reality educational spaces or environments, collaborative holographic workspaces for simultaneous interaction with one or more three-dimensional educational objects; peer-to-peer immersive interaction within the virtual educational spaces or environments. In some embodiments, the server 110-1 is also configured to deploy, via the deployment abstraction layer 240-2, one or more functions of generative AI layer 220-2 of the server 110-1 on one or more additional servers (not shown) based on the complexity and the processing requirement required corresponding to the at least one determined immersive educational content to be generated.

In some embodiments, the server(s) 110 is also configured to gamify, via the gamification layer 225-2, the generated immersive educational content(s). In some embodiments, the server 110-1 is configured to generate the immersive educational content(s) and/or the gamify the generated immersive educational content(s) based on one or more large language model (LLM) datasets and/or data repositories stored in the server memory 405 and/or one or more data sources including, but not limited to, the Internet, third-party servers, and application programming interfaces (APIs). As an example, the server 110-1 is configured to generate, via the gamification layer 225-2, one or more digital videogames aligned with the determined learner profile and educational objectives defined in the determined educational framework. In some embodiments, the server(s) 110 is also configured to generate and include, via the gamification layer 225-2, at least one game logic, rule, level, and/or physics system corresponding to the at least one generated immersive educational content in order to gamify the at least one generated immersive educational content. In some embodiments, the server 110-1 is configured to provide, via the server transceiver 410 and the network 120, the generated and/or gamified immersive educational content(s) corresponding to each educational element of the determined educational element(s) to the user device 115-1 and/or the robot(s) 125 for the at least one commenced educational session. In embodiments when multiple user devices, for example, 115-1, 115-2 associated with the same user are registered and/or authenticated by the server 110-1 corresponding to the commenced educational session, the server 110-1 is configured to provide the immersive educational content(s) to the user devices, for example, 115-1, 115-2 such that the immersive educational content(s) is synchronously displayed on both the user devices, for example, 115-1, 115-2. In some embodiments, the server 110-1 is configured to provide the same or different immersive educational content(s) that are inter-related or independent of each other corresponding to each user device of the multiple user devices, for example, 115-1, 115-2 of the same user. In such embodiments, the server 110-1 is also configured to coordinate, via the generative AI layer 220-2 and/or the gamification layer 225-2, a content presentation across the multiple user devices, for example, 115-1, 115-2 to create a unified educational experience. For example, the server 110-1 is configured to provide a first generated immersive educational content in an audio format to a first user device 115-1 and a second generated immersive educational content in an interactive visual 2-D and/or 3D format to a second user device 115-2 such that the content presentation of the first generated immersive educational content via the first user device, for example, 115-1 coordinates with the content presentation of the second generated immersive educational content, for example, 115-2. Similarly, as another example, the server 110-1 is configured to provide the first generated immersive educational content as images, and/or illustrations, for example, an X-ray or an illustration of human body organs, to the first user device 115-1 and the second generated immersive educational content to the second user device 115-2 as descriptive text associated with images/illustrations provided to the first user device, for example, 115-1. In some embodiments, the server 110-1 is also configured to adaptively modify the at least one immersive educational content provided on the multiple user devices, for example, 115-1, 115-2 based on at least one user input or user-initiated change received, via at least one of the input device(s) 135, for example, the user input device 135-1 of the first user device 115-1. For example, for instances, when the first generated immersive educational content is provided by the server 110-1 to the first user device 115-1 as images, and/or illustrations, for example, an X-ray or an illustration of human body organs, the server 110-1 is configured to adaptively modify the descriptive text provided to the second user device 115-2 upon receiving at least one user input corresponding to the images/illustrations provided to the first user device 115-1.

In some embodiments, the server 110-1 is configured to receive, via the generative AI layer 220-2, the determined session event(s) by the user device(s) 115-1 and/or the robot(s) 125 via the network 120. In some embodiments, in response, the server 110-1 is configured to modify, via the generative AI layer 220-2, the previously determined context based on the determined session event(s). In some embodiments, the server 110-1 is configured to modify, via the generative AI layer 220-2, the previously generated immersive educational content(s) corresponding to each educational element of the determined educational element(s) based on the modified context and the received session event(s). In such embodiments, the server 110-1 is also configured to modify, via the generative AI layer 220-2, the difficulty level of the modified immersive educational content(s) to be lesser or greater in comparison to the previously rendered immersive educational content(s). In some embodiments, the server 110-1 is also configured to modify, via the generative AI layer 220-2, the response, the tone, the animation, and/or the presentation style of the 2D or 3D avatar based on the received determined session event(s). In some embodiments, the server 110-1 is configured to provide, via the generative AI layer 220-2, the modified generated immersive educational content(s) to the user device(s) 115, for example, 115-1, 115-2 and/or the robot(s) 125 during the commenced educational session(s) in real-time. In some embodiments, the server 110-1 is also configured to continuously adapt, generative AI layer 220-2, the at least one generated immersive educational content based on the one or more real-time inputs received from the user device(s) 115, the input device(s) 135, the IoT device(s) 130, and/or the robot(s) 125 in addition to the determined session event(s) received from the user device(s) 115-1 and/or the robot(s) 125. In some embodiments, the server 110-1 is configured to continuously and/or adaptively modify a complexity, a presentation format, and/or a delivery timing associated with the at least one generated immersive educational content based on the one or more real-time inputs. As an example, the server 110-1 is also configured to adaptively modify, via the generative AI layer 220-2, the at least one immersive education content to include at least one gesture-controlled content based on one or more of the determined sessions event(s) and/or the one or more real-time inputs including, but not limited to, hand, body, and facial gestures of the user. As another example, the server 110-1 is configured to adaptively modify, via the generative AI layer 220-2, the at least one immersive education content to include eye-tracking responsive presentations that adapt based on the determined session event(s) and/or the one or more real-time inputs including, but not limited to, user gaze patterns and attention focus. In yet another example, the server 110-1 is configured to adaptively modify, via the generative AI layer 220-2, the at least one immersive education content to include brain-computer interface content based on the determine session event(s) and/or the one or more real-time inputs including, but not limited to, electroencephalography and neural response measurements of the user. In yet another example, the server 110-1 is configured to adaptively modify, via the generative AI layer 220-2, the at least one immersive education content to include voice-modulated content based the determine session event(s) and/or the one or more real-time inputs including, but not limited to, on vocal stress and emotional indicators associated with the user. In yet another example, the server 110-1 is configured to adaptively modify, via the generative AI layer 220-2, the at least one immersive education content to include biometric-responsive content that adapts to the determine session event(s) and/or the one or more real-time inputs including, but not limited to, one or more physiological measurements including, but not limited to, heart rate and skin conductance.

In some embodiments, the server 110-1 is also configured to perform modeling of one or more distance cues, occlusion effects, diffraction effects, and/or Doppler effects based on the at least one real-time input received via the user device(s) 115, the robot(s) 125, the IoT device(s) 130, and/or the input device(s) 135, and modulate the at least one provided immersive educational content and/or the at least one spatial audio content included in the at least one provided immersive educational content based on the modeling. In some embodiments, the server 110-1 is also configured to track head and/or physical body movements of the user associated with the at least one commenced educational session based on the one or more received real-time inputs via the user device(s) 115, the robot(s) 125, the IoT device(s) 130, and/or the input device(s) 135 and update and/or modify the at least one spatial audio content included in the at least one provided immersive educational content based on the tracked head and/or physical body movements. In some embodiments, the one or more additional user devices, for example, 115-2 also correspond to one or more audio speakers including, but not limited to, headphones/earbuds, near-ear speakers, soundbars, room or vehicle speakers, or robotic arrays associated with the user and registered corresponding to the at least one commenced education session. In such embodiments, the server 110-1 is configured to provide, via the generative AI layer 220-2, the at least one spatial audio content to the one or more audio speakers. In some embodiments, the server 110-1 is configured to implement one or more spatial audio techniques including, but not limited to, amplitude/energy panning, ambisonic/HOA decoding, beamforming, wavefield synthesis, and/or transaural techniques for loudspeaker reproduction of the at least one spatial audio content. In some embodiments, the server 110-1 is configured to determine, via the generative AI layer 220-2, one or more spatial parameters including, but not limited to, a position, an orientation, a velocity, one or more distance cues, an occlusion, a reverberation, and/or a room response associated with the at least one spatial audio content provided along with the at least one provided immersive educational content based on the one or more real-time inputs received from the user device(s) 115, the robot(s) 125, the IoT device(s) 130, and/or the input device(s) 135. In such embodiments, the server 110-1 is configured to generate and output, via the generative AI layer 220-2, one or more audio objects, ambisonic signals, channel-based beds, or renderer-agnostic metadata corresponding to the at least one spatial audio content to modulate the at least one spatial audio content based on the one or more determined spatial parameters. In some embodiments, the server 110-1 is also configured to enforce and/or implement, via the administrative layer 230-2, one or more intelligibility, accessibility, and safety constraints corresponding to the at least one spatial audio content. For example, the server 110-1 is also configured to prevent, via the administrative layer 230-2, spatial masking of one or more critical instructions provided in the at least one spatial audio content. Further, the server 110-1 is also configured to selectively, via the deployment abstraction layer 240-2, provide the at least one spatial audio content on one or more devices, for example, the user devices 115-1 and/or 115-2 based one or more content delivery parameters including, but not limited to, latency and/or synchronization parameters associated with the at least one spatial audio content and/or at least one provided immersive educational content across the user device(s) 115.

In some embodiments, the server 110-1 is also configured to generate, via the generative AI layer 220-2, one or more assessment tests associated with the provided immersive educational content(s) corresponding to the determined educational element(s). In some embodiments, the one or more generated assessment tests include, but are not limited to, one or more spatial assessment tasks requiring physical movement and object manipulation by the user in a 3D space. In some embodiments, the server 110-1 is also configured to provide, via the generative AI layer 220-2, the generated assessment test(s) to the user device(s) 115 and/or the robot(s) 125 during or after a completion of the displayed immersive educational content(s) and/or the modified immersive educational content(s) on the user device(s) 115 and/or the robot(s) 125 for the commenced educational session, or after the completion of the plurality of educational sessions corresponding to the plurality of educational elements in the determined predefined education sequence. In some embodiments, the server 110-1 is also configured to receive a request to generate and provide the assessment test(s) corresponding to the provided immersive educational content(s) from the user device(s) 115 and/or the robot(s) 125. In some embodiments, the server 110-1 is configured to generate, via the generative AI layer 220, the assessment test(s), based on the one or more LLM datasets and/or data repositories stored in the server memory 405 and/or the one or more data sources including, but not limited to, the Internet, third-party servers, and application programming interfaces (APIs). In some embodiments, the server 110-1 is also configured to verify, via the administrative layer 230-2, the compliance of the generated assessment test(s) corresponding to the educational element(s) with the determined educational framework(s). In some embodiments, the server 110-1 is configured to perform the verification via one or more third party servers (not shown) or APIs associated with one or more education governing entities.

In some embodiments, the server 110-1 is also configured to receive, via the generative AI layer 220-2, the tracked progress and/or the user performance corresponding to the at least one assessment test, the modified context, and/or the determined session event(s) corresponding to the provided assessment test(s) from the user device(s) 115, the robot(s) 125, and/or the IoT device(s) 130 via the network 120. In some embodiments, the server 110-1 is configured to modify, via the generative AI layer 220-2, the assessment test(s) generated corresponding to the predefined education element(s) based on the received tracked progress and/or the user performance, the modified context, and/or the determined session event(s) corresponding to the provided assessment test(s). In some embodiments, the server 110-1 is configured to modify, via the generative AI layer 220-2, the difficulty level of the modified assessment test(s) to be less than or greater than the previously provided assessment test(s). In some embodiments, the server 110-1 is configured to provide, via the generative AI layer 220-2, the modified assessment test(s) to the user device(s) 115, for example, 115-1, 115-2 and/or the robot(s) via the network 120.

In some embodiments, the server 110-1 is also configured to receive, via the administrative layer 230-2, the tracked progress and/or the user performance corresponding to the assessment test(s) upon completion of the assessment test(s) from the user devices(s) 115 and/or the robot(s) 125 via the network 120. In some embodiments, the user performance corresponds to one or more inputs including, but not limited to, text inputs, audio and/or video recordings, and one or more tactile inputs, associated with the at least one assessment test received from the input device(s) 135, the user device(s) 115, the robot(s) 125, and/or the IoT device(s) 130 upon completion of the assessment test(s). In some embodiments, the server 110-1 is configured to verify, via the administrative layer 230-2, the compliance of the received user performance corresponding to the educational element(s) with the determined educational framework(s). In such embodiments, the server 110-1 is also configured to evaluate, via the administrative layer 230-2, the recorded user performance based on the verification and at least one rule associated with the predefined education framework(s). As an example, the server 110-1 is also configured to evaluate, via the administrative layer 230-2, 3D hand trajectories, gesture accuracy, and one or more spatial problem-solving patterns of the user for competency assessment based on the video recordings received from the user device(s) 115. In some embodiments, the server 110-1 is also configured to provide, via the IoT device(s) 130, at least one haptic feedback for correct and incorrect responses provided to the user device(s), for example, the user device 115-1 by the user corresponding to the at least one assessment test based on the evaluation of the user performance in real-time. In some embodiments, the server 110-1 is also configured to update, via the administrative layer 230-2, the learner profile of the user with at least one user achievement data based on verification and the evaluation. In some embodiments, the server 110-1 is configured to perform the verification, evaluation, and updating of the leaner profile via one or more third party servers (not shown) or APIs associated with one or more education governing entities.

In some embodiments, the server 110-1 is also configured to implement, via the administrative layer 230-2, one or more region-specific rules, regulations, and/or ethical guidelines across the plurality of deep learning layers, for example, 210 through 225, 240 such that the one or more functions performed by each layer is governed based on such implementation. For example, the server 110-1 is configured to apply the one or more country, region, and/or educational framework related rules, regulations, and/or ethical guidelines to generate the at least one assessment test associated with the at least one educational session, determine the user performance corresponding to the at least one assessment test, evaluate the user performance, update the learner profile and/or educational credentials associated with the user. In some embodiments, the server 110-1 is also configured to detect, determine, and propagate, via the administrative layer 230-2, one or more policy changes and/or updates to the country, region, and/or educational framework related rules, regulations, and/or ethical guidelines to the remaining deep learning layers, for example, 210 through 225, 240. In some embodiments, the server 110-1 is also configured to manage, via the administrative layer 230-2, the country, region, and/or educational framework related rules, regulations, and/or ethical guidelines associated with one or more third-party governing entities and automatically coordinate the implementation across the remaining deep learning layers, for example, 210 through 225, 240 based on one or more factors including, but not limited to, the determined context associated with the each commenced educational session, the determined learner profile, the determined educational credential(s) associated with the user, the determined educational framework associated with the determined learner profile, the third-party entity of the one or more third-party governing entities associated with the determined educational framework. In some embodiments, the server 110-1 is configured to manage, via the administrative layer 230-2, credential lifecycle operations including, but not limited to, issuance, verification, modification, and revocation of the educational credentials and/or educational documents, associated with the user. In some embodiments, the server 110-1 is also configured to authenticate, via the administrative layer 230-2, the educational credentials using cryptographic verification protocols. In some embodiments, the server 110-1 is also configured to coordinate, via the administrative layer 230-2, cross-institutional credential recognition and portability of the educational credentials of the user between the one or more third party governing entities, and/or the one or more educational frameworks. In some embodiments, the server 110-1 is also configured to assess, via the administrative layer 230-2, the at least one generated immersive educational content for accuracy and pedagogical effectiveness prior to providing the at least one generated immersive educational content to the user device(s) 115 and/or the robot(s) 125. In some embodiments, the server 110-1 is also configured to validate, via the administrative layer 230-2, the at least one generated immersive educational content against the country, region, and/or educational framework related rules, regulations, and/or ethical guidelines, the determined educational framework or standards. In some embodiments, the server 110-1 is also configured to optimize, via the administrative layer 230-2, a content quality of the at least one generated immersive educational content through automated improvement recommendations provided to the generative AI layer 220-2.

In some embodiments, the server 110-1 is also configured to generate, via the administrative layer 230-2, one or more progress reports associated with the user and compliance documentation associated with the at least one generated immersive content, the at least one generated assessment test, the determination of the user performance, the evaluation, the updating of the educational credentials and/or documents. In such embodiments, the server 110-1 is configured to provide via the administrative layer 230-2, the generated reports and the compliance documentation to the third-party governing entities associated with the determined educational framework associated with the user for reference and validation. In such embodiments, the server 110-1 is also configured to customize, via the administrative layer 230-2, reporting content in the generated reports and the compliance documentation based on one or more roles and requirements of the third-party governing entities, or one or more individuals associated with the third-party governing entities. In some embodiments, the server 110-1 is also configured to aggregate, via the administrative layer 230-2, educational data including, but not limited to, the learner profile, the educational credentials and/or documents, the generated progress reports, and the compliance documentation, associated with the user from one or more of the remaining layers, for example, the blockchain layer 235-2. In some embodiments, the server 110-1 is also configured to provide, via the administrative layer 230-2, the aggregated educational data to one or more the third-party governing entities or between the third-party entities while also preserving confidentiality of the shared education data.

In some embodiments, the server 110-1 is configured to store, via the blockchain layer 235-2, at least one timestamped educational record or credential associated with the user. In some embodiments, the server 110-1 is configured to store, via the blockchain layer 235-2, at least one timestamped record of the updated learner profile, the recorded user performance, the evaluation, the updated educational credentials and/or documents, the generated reports, the compliance documentation, the aggregated educational data, information related to transfer and/or sharing of the educational data, or any activity performed and/or output of one or more of the remaining layers, for example, 210 through 230, 240 in at least one blockchain ledger stored and/or managed in the server 110-1 and/or one or more additional servers, for example, 110-2 . . . 110-n. In some embodiments, the server 110-1 is also configured to generate, via the blockchain layer 235-2, the at least one timestamped credential corresponding to each user achievement data of the at least one user achievement data included in the updated learner profile. In some embodiments, the server 110-1 is also configured to receive, via the blockchain layer 235-2, the server transceiver 410 and the network 120, the permission or the revocation of the permission to access the at least one stored educational record or credential, the determined and/or updated learner profile, the user achievement data, and/or the recorded and/or evaluated user performance associated with the user by third-party entities from the user device(s) 115 and/or the robot(s) 125. In some embodiments, the server 110-1 is also configured to merge, via the blockchain layer 235-2, the educational record(s) or credential(s), the updated learner profile, and/or the user achievement data into a composite record. In some embodiments, the server 110-1 is also configured to enable the merged composite record to be exported, provided, and/or made accessible to at least one third party-entity based on the received permission.

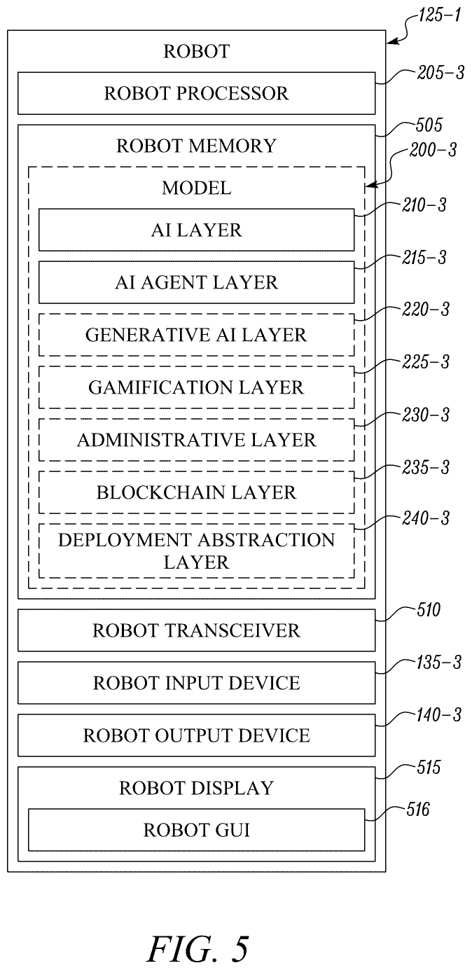

Referring to FIG. 5, various components of the robot 125-1 (see FIG. 1) are illustrated. It will be apparent to those with ordinary skill in the art that the remaining robots, for example, 125-2 . . . 125-n are also configured to include similar components that perform corresponding functions as described hereinafter with respect to the components of the robot 125-1. The robot 125-1 includes, among other components, the processor 205-3, herein referred to as the ‘robot processor 205-3’, a robot memory 505, a robot transceiver 510, a robot display 515, the input device, for example, 135-3, herein referred to as the ‘robot input device 135-3’, and the output device, for example, 140-3, herein referred to as the ‘robot output device 140-3’. The components of the robot 125-1, including the robot processor 205-3, the robot memory 505, the robot transceiver 510, the robot display 515, the robot input device 135-3, and the robot output device 140-3 cooperate with one another to enable operations of the robot 125-1. It will be apparent to those skilled in the art the robot 125-1 is configured to include one or more moving parts and one or more actuating parts associated with the moving parts. Examples of the moving part(s) include, but are not limited to, robot limbs, fingers, and/or joints. Examples of the actuating part(s) include, but are not limited to, electronic switches, gears, motors, and actuators configured to manipulate and displace the moving part(s). Each component communicates with one another via a robot local interface (not illustrated). The robot local interface includes, but not limited to, one or more buses or other wired or wireless connections, as is known in the art. The robot local interface includes additional elements, which are omitted for simplicity, such as controllers, buffers (caches), drivers, repeaters, and receivers, among many others, to enable communications. Further, the robot local interface includes address, control, and/or data connections to enable appropriate communications among the aforementioned components.

The robot input device 135-3 is configured to communicate information and command selections to the robot processor 205-3. Examples of the robot input device 135-3 include, but are not limited to, a keyboard, a touch screen display, a camera, a touch pad, a microphone, a recorder, a mouse or any other user input mechanism now known or developed in the future. It will be understood by those with ordinary skill in the art that although the robot input device 135-3 is illustrated as a single device, the robot 125-1 is configured to include multiple input devices. In some embodiments, the robot input device 135-3 also includes one or more sensors including, but are not limited to, the motion sensors, the environmental sensors and the position sensors. In some embodiments, the robot input device 135-3 also corresponds to one or more peripheral input devices capable of being paired with the user device 115-1 via the network 120 (see FIG. 1), for example, a wireless network including, but not limited to, a Bluetooth, Wi-Fi, or a Wi-Fi direct network, or as a wired network or hardware connection such as, but not limited to, a USB peripheral to the robot 125-1. Examples of the peripheral input devices include, but are not limited to, a joystick, a gamepad, a keyboard, a mouse, a gesture-controlled device, or a wearable device such as, for example, a smart watch.

The robot display 515 is configured to display data, images, and the like. The robot display 515 includes a display screen or a computer monitor or any other display mechanism now known or in the future developed. Examples of the robot display 515 include, but are not limited to, a light emitting diode (LED) display and a liquid crystal display (LCD) display. In accordance with various embodiments, the robot display 515 and/or the robot output device 140-3 are configured to display and/or provide at least one immersive educational content.

The robot transceiver 510 is configured to transmit data and/or signals to and receive data and/or signals from one or more other components of the server(s) 110, the user device(s) 115, and/or the IoT device(s) 130. For example, the robot transceiver 510 is configured to transmit input data captured from the robot input device 135-3 to the server(s) 110, the robots(s) 125, and/or the IoT device(s) 130 and similarly, receive the input from the server(s) 110, the robots(s) 125, and/or the IoT device(s) 130. The robot transceiver 510 includes a transmitter circuitry and a receiver circuitry to enable the robot 125-1 to communicate with the one or more other components. In this regard, the transmitter circuitry includes appropriate circuitry to transmit the one or more signals to the one or more other components and the receiver circuitry includes appropriate circuitry to receive the one or more signals from the one or more other components. It will be appreciated by those of ordinary skill in the art that the robot 125-1 includes a single robot transceiver 510 as illustrated, or alternatively separate transmitting and receiving components, for example but not limited to, a transmitter, a transmitting antenna, a receiver, and a receiving antenna.

The robot memory 505 is a non-transitory memory configured to store a set of instructions that are executable by the robot processor 205-3 to perform predetermined operations. For example, the robot memory 505 includes any of the volatile memory elements (for example, random access memory (RAM)), non-volatile memory elements (for example, read only memory (ROM)), and combinations thereof. Moreover, the robot memory 505 incorporates electronic, magnetic, optical, and/or other types of the non-transitory storage media. In accordance with various embodiments, the robot memory 505, for example, is configured to store a learner profile of a user at least one educational framework associated with the user, a session identifier generated corresponding to each educational session, an education delivery sequence corresponding to the at least one determined educational framework, a hierarchy of educational elements in the education delivery sequence, at least one immersive educational content generated, modified, and/or gamified corresponding to each educational element in the education delivery sequence, one or more session events determined during one or more educational sessions, one or more assessment tests generated corresponding to each learner profile, a user performance recorded corresponding to the one or more assessment tests, an evaluation of the user performance, registration details of the user and/or the robot 125-1 and/or the robots, for example, 125-2 . . . 125-n, one or more timestamped educational records or credentials associated with the user, a composite of the timestamped educational record(s) or credential(s) associated with the user, environmental data, behavioral data, emotional data, and/or biometric data associated with a user, one or more recommendations, speed of content delivery, and/or difficulty level of the at least one immersive educational content. In accordance with various embodiments, the robot memory 505, for example, is also configured to store the model 200 (see FIG. 2) and one or more deep learning layers, for example, the AI layer 210 (see FIG. 2), the AI agent layer 215 (see FIG. 2) of the plurality of the deep learning layers, for example, 210 through 240 (see FIG. 2) in the model 200. In some embodiments, the robot memory 505, for example, is also configured to store one or more additional deep learning layers, for example, 220 through 240 (see FIG. 2) of the model 200. The model 200, the AI layer 210 (see FIG. 2), the AI agent layer 215 (see FIG. 2), the optionally included deep learning layers, for example, 220 through 240 included in the robot memory 505 are referred to herein as the “model 200-3”, the “AI layer 210-3”, the “AI agent layer 215-3”, the “generative AI layer 220-3”, the “gamification layer 225-3”, the “administrative layer 230-3”, the “blockchain layer 235-3”, and the “deployment abstraction layer 240-3” respectively.

The robot processor 205-3 is configured to execute the instructions stored in the robot memory 505 to perform different operations. The robot processor 205-3 includes one or more microprocessors, microcontrollers, DSPs (digital signal processors), state machines, logic circuitry, or any other device or devices that process information or signals based on operational or programming instructions. The robot processor 205-3 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The robot processor 205-3 is configured to cooperate with other components of the robot 125-1 and/or the implement one or more deep learning layers, for example, 210-3 through 235-3 to perform the operations.

In accordance with various embodiments, the robot 125-1 is configured to implement and perform the functions of the plurality of deep learning layers, for example, 210-3 through 215-3 similar to functions of the plurality of deep learning layers, for example, 210-1 (see FIG. 3) through 215-1 (see FIG. 3) performed by the user device 115-1 as described with reference to FIG. 3 in the present disclosure. It will be apparent to those with ordinary skill in the art that the robot 125-1 is also configured to interact with the server(s) 110 (see FIG. 1), for example, 110-1 (see FIG. 5) similar to the user device 115-1 interacting with the server(s) 110 as described with reference to FIG. 3 in the present disclosure. Further, it will also be apparent to those with ordinary skill in the art that in embodiments when the robot 125-1 optionally includes the additional layers, for example, 220-3 through 235-3, in the robot memory 505, the robot 125-1 is also configured to perform the functions of the additional layers, for example, 220-3 through 235-3 similar to the functions of the optionally included additional layers, for example, 220-1 (see FIG. 3) through 235-1 (see FIG. 3) performed by the user device 115-1 as described with reference to FIG. 3 in the present disclosure.

In addition, in some embodiments, the robot 125-1 is also configured to provide at least one physical gesture associated with the at least one rendered and/or modified immersive educational content displayed via a robot GUI 516 of the robot display 515. Further, in some embodiments, the robot 125-1 is also configured to retrieve anonymized learner data associated with the user interacting with the rendered immersive educational content(s) via the robot input device, for example, 135-3 and/or the IoT device(s) 130 in communication with the robot 125-1 via the network 120. In some embodiments, the robot 125-1 is also configured to provide, via the robot display 515, an interactive learning interface including, but not limited to, one or more holograms, projector presentations, and/or virtual or augmented reality presentations or projections associated with the at least one rendered immersive educational content based on the retrieved anonymized learner data.

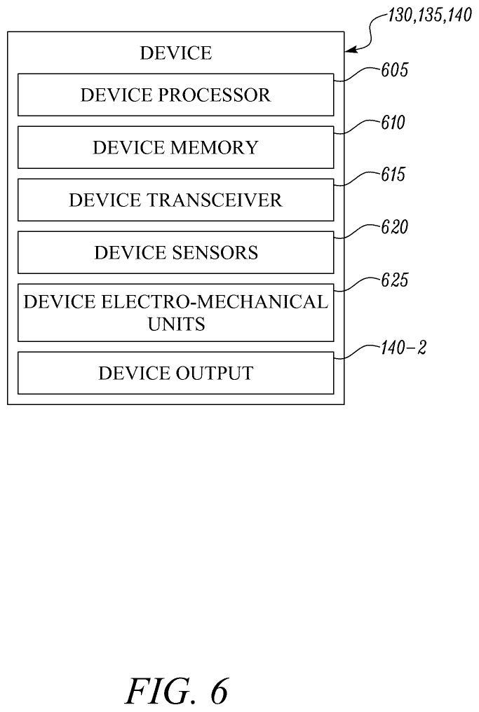

Referring to FIG. 6, various components included in each device of the output device(s) 140, the input device(s) 135 and/or the IoT device(s) 130, herein referred to as the “device 130, 135, 140” are illustrated. The device 130, 135, 140 includes, among other components, a device processor 605, a device memory 610, a device transceiver 615, and the output device, for example, 140-2, herein referred to as ‘device output 140-2’. The components of the device 130, 135, 140, including the device processor 605, the device memory 610, the device transceiver 615, and the device output 140-2 cooperate with one another to enable operations of the device 130, 135, 140. In some embodiments, the device 130, 135, 140 is configured to capture, via the device processor 605, the one or more real-time inputs from the environment 100 (see FIG. 1) including one or more of the user device(s) 115 and/or the user associated with the at least one commended educational session. In some embodiments, the device 130, 135, 140 also includes one or more device sensors 620 and device electro-mechanical units 625 including, but not limited to, fluid dispensing units, vibration units, thermal units, and fluid pressure inducing units configured to provide haptic feedback and/or tactile experiences to the users via the device 130, 135, 140 and simulate physical effects including, but not limited to, wind, water, and scent. In some embodiments, the device 130, 135, 140 is configured to be a smart wearable, a 4-dimensional (4D) seat or chair with movement along 3D axes, and a smart speaker. In accordance with various embodiments, the device output 140-2 is configured to provide the at least one immersive educational content received from the server 110-1 and/or the user device(s) 115, for example 115-1. In some embodiments, the device output 140-2 also includes the one or more device sensors 620 and the device electro-mechanical units 625.

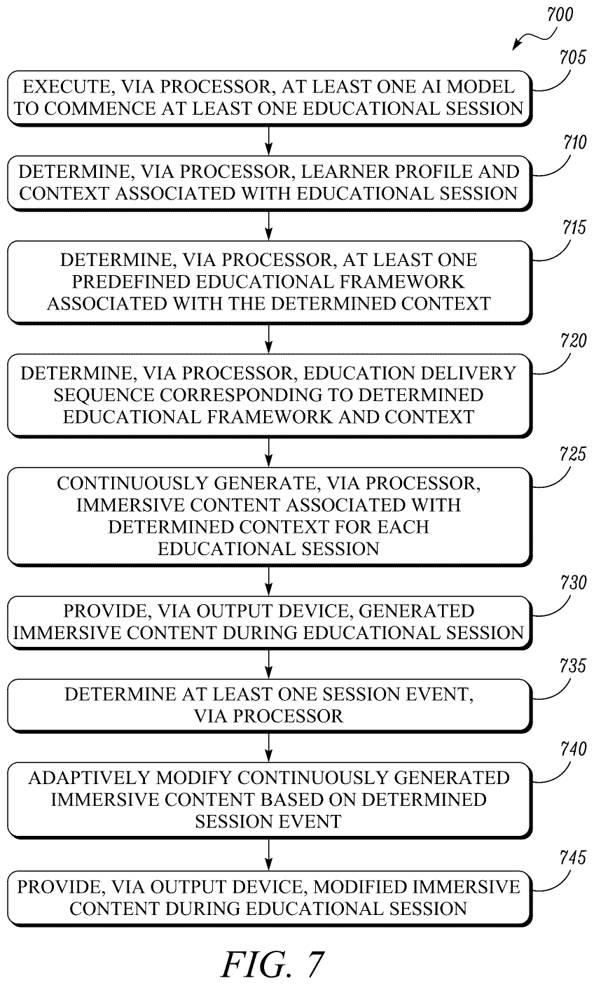

Referring to FIG. 7, a method 700 implemented by the server(s) 110 (see FIG. 1), the user device(s) 115 (see FIG. 1), and the robot(s) 125 (see FIG. 1) independently or in combination is described. It will be apparent to those with ordinary skill in the art that 705 through 745 of the method 700 are implement by the server(s) 110, the user device(s) 115, and/or the robot(s) 125 based on the one or more deep learning layers, for example, 210 through 240 of the model 200 (see FIG. 2) included in the server(s) 110, the user device(s) 115, and/or the robot(s) 125. At 705, at least one processor, for example, 205-1 (see FIG. 3), 205-2 (see FIG. 4), 205-3 (see FIG. 5) is configured to implement the AI layer 210 for executing the model 200 to commence the at least one educational session. At 710, the at least one processor, for example, 205-1, 205-2, 205-3 is configured to implement the AI layer 210 for determining, via the input device(s) 135, the learner profile and the context associated with each educational session of the at least one educational session. At 715, the at least one processor, for example, 205-1, 205-2, 205-3, is configured to implement the AI agent layer 215 for determining the at least one educational framework associated with the determined context and the determined learner profile. At 720, the at least one processor, for example, 205-1, 205-2, 205-3 is configured to implement the AI agent layer 215 for determining the education delivery sequence corresponding to the at least one determined educational framework and the determined context. At 725, the at least one processor, for example, 205-1, 205-2, 205-3 is configured to implement the generative AI layer 220 for generating the at least one immersive educational content associated with the determined context based on the determined education delivery sequence for the at least one educational session. At 730, the at least one processor, for example, 205-1, 205-2, 205-3 is configured to implement the generative AI layer 220 for the rendering, via the display, for example, 315 (see FIGS. 3), 515 (see FIG. 5), the at least one immersive educational content. At 735, the at least one processor, for example, 205-1, 205-2, 205-3 is configured to implement the generative AI layer 220 for determining, via the input device(s) 135, the at least one session event during the at least one educational session. At 740, the at least one processor, for example, 205-1, 205-2, 205-3 is configured to implement the generative AI layer 220 for adaptively modifying the at least one generated immersive educational content based on the at least one determined session event. At 745, the at least one processor is configured to implement the generative AI layer 220 for rendering, via the display, for example, 315, 515, and the processor(s) 205, the at least one modified immersive educational content.

It will be apparent that the system 105 and the method 700 as described in the present disclosure, enable autonomous delivery of personalized and/or customized education to a user by actively managing and monitoring each educational session implemented via the server(s) 110, the user device(s) 115, and/or the robot(s) 125. The system 105 and the method 700 as described in the present disclosure, also enable delivery of continuously engaging educational material, via the immersive educational content including animations, graphics, 2D or 3D avatars, to the user, such that the user is capable of independently exploring, questioning, and better understanding the education imparted in-depth. Further, based on the monitoring, the system 105 and the method 700 as described in the present disclosure, also facilitates continuous determination of the user behavior, the user biometrics, and other environmental factors during each educational session, such that the immersive educational content provided to the user is adaptively modified based on the determined user behavior, user biometrics, and/or the environmental factors. In addition, the system 105 and the method 700 as described in the present disclosure, also enable independent and automated assessment of the user via the gamified immersive educational content(s) and/or assessment test(s) presented to the user upon completion of the one or more educational elements defined within the educational frameworks. Further, the system 105 and the method 700 as described in the present disclosure, also ensure compliance of the imparted education with one or more educational frameworks and/or one or more governing educational entities or bodies. The system 105 and the method 700 as described in the present disclosure, also ensure compliance of the assessment(s) provided, and/or the assessment conducted with one or more governing educational entities or bodies. The system 105 and the method 700 as described in the present disclosure, also facilitate assessment of the user's learning via one or more third party entities such as the one or more governing educational entities, schools, colleges, and/or universities. Furthermore, the system 105 and the method 700 as described in the present disclosure, with aid of the robot(s) 125 and robotic gestures, assist in emulating and fulfilling roles of real-life educators, and thereby help in providing a friendly and meaningful experience to the user during the educational session(s).

In the hereinbefore specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that can cause any benefit, advantage, or solution to occur or become more pronounced are not to be construed as a critical, required, or essential feature or elements of any or all the claims. The invention is defined solely by the appended claims including any amendments made during the pendency of this application and all equivalents of those claims as issued.

Moreover, in this document, relational terms such as first and second, top and bottom, and the like are used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but includes other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but also be configured in ways that are not listed.

It will be appreciated that some embodiments are comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

We claim:

1. An autonomous education system, comprising:
at least one input device;
at least one output device;
at least one user device communicatively coupled with the at least one input device and the at least one output device, wherein the at least one user device comprises a user device processor and a user device memory for storing instructions and at least one user device artificial intelligence (AI) model, that when executed by the user device processor, causes the at least one user device to:
commence at least one educational session,
determine, via the at least one input device, a learner profile and a context associated with each educational session of the at least one educational session,
determine at least one educational framework associated with the determined context and the determined learner profile,
determine an education delivery sequence corresponding to the at least one determined educational framework and the determined context, and
provide, via a user device transceiver of the at least one user device, the determined context, the determined learner profile, the determined education delivery sequence to a server; and
the server in communication with the at least one user device, the server comprising a server processor and a server memory for storing instructions and at least one server artificial intelligence (AI) model, that when executed by the server processor, causes the server to:
generate at least one immersive educational content associated with the determined context based on the determined education delivery sequence for the at least one educational session, and
provide the at least one generated immersive educational content to the at least one output device,
wherein the at least one output device is configured to:
provide the at least one immersive educational content received from the server corresponding to the at least one commenced educational session,
wherein the at least one input device is configured to:
determine at least one session event during the at least one commenced educational session, and
provide the at least one determined session event to the server, wherein the server is configured to modify the at least one generated immersive educational content based on the at least one determined session event and provide the at least one modified immersive educational content to the at least output device, and the at least one output device is configured to adaptively modify the at least one provided immersive educational content and provide the at least one modified immersive educational content received from the server during the at least one commenced educational session.

2. The autonomous education system of claim 1, wherein the server is configured to:
gamify, via the server processor and the at least one server AI model, the at least one generated immersive educational content; and
provide the at least one gamified immersive educational content to the at least one user device,
track, via the at least one user device, a user performance corresponding to the at least one gamified immersive educational content; and
provide at least one performance indication, a reward, or a combination thereof to the at least one user device based on and associated with the tracked user performance.

3. The autonomous education system of claim 1, wherein the server is configured to:
generate, via the server processor and the server AI model, at least one assessment test associated with the at least one provided immersive educational content corresponding to the at least one educational session, or the at least one educational session corresponding to a plurality of educational sessions, and
provide the at least one generated assessment test to the at least one user device, and wherein the at least one user device is configured to:
record, via the at least one input device and the user device processor, a user performance corresponding to the at least one provided assessment test; and
provide to the recorded user performance to the server.

4. The autonomous education system of claim 3, wherein the server is configured to:
verify, via the server processor, a compliance of the at least one provided assessment test, the recorded user performance, or a combination thereof with the at least one determined educational framework;
evaluate, via the server processor, the recorded user performance based on the verification and at least one rule associated with the at least one predefined education framework; and
update, via the server processor, the learner profile based on verification and the evaluation; and
store, via the server processor, at least one timestamped record of the updated learner profile, the recorded user performance, the evaluation, or any combination thereof in at least one blockchain ledger.

5. The autonomous education system of claim 1, wherein the server is configured to register and authenticate, via the server processor, a user and at least one user device operated by the user prior to the commencement of the at least one educational session, the at least one user device comprising or being in communication with the server.

6. The autonomous education system of claim 5, wherein the server is configured to:
store at least one timestamped educational record or credential associated with the user, wherein the server is configured to authenticate the user and the at least one user device or determine the learner profile based on the at least one stored educational record or credential in the server.

7. The autonomous education system of claim 6, wherein the user device is configured to:
determine, via the user device transceiver, a connectivity to a network during or prior to the commencement of the at least one educational session;
queue, via the user device processor, at least one action associated with the learner profile or the at least one timestamped educational record or credential associated with the user when the determined connectivity is indicative of an unavailability of the network; and
initiate, via the user device processor, the at least one action when the determined connectivity is indicative of an availability of the network.

8. The autonomous education system of claim 6, wherein the at least one timestamped educational record comprises at least one user achievement data, and the at least one user achievement data comprises at least one test score, certification, transcript, grade, course completion acknowledgement, or any combination thereof, and wherein the at least one user device is configured to:
generate, via the user device processor, the at least one timestamped record or credential corresponding to each user achievement data of the at least one user achievement data; and
receive, via the at least one input device, a permission or a revocation of permission to access the at least one stored educational record or credential.

9. The autonomous education system of claim 6, wherein the server is configured to:
merge the at least one stored educational record or credential into a composite record, wherein the merged composite record is exportable, provided, or made accessible to at least one third party-entity.

10. The autonomous education system of claim 1, wherein the at least one user device is configured to:
assign a session identifier corresponding to each educational session of the at least one educational session;
record the assigned session identifier and a completion or a progress of the determined education delivery sequence based on the at least one provided immersive educational content during the at least one educational session;
store the assigned session identifier and the at least one provided immersive educational content corresponding to the recorded completion or progress of the determined education delivery sequence; and
provide, via the at least one output device, the at least stored immersive educational content in response to an input received via the at least one input device.

11. The autonomous education system of claim 1, wherein the at least one output device, the at least one input device, or a combination thereof corresponds to at least one robotic device, and wherein the at least one robotic device is configured to at least one of:
provide at least one physical gesture associated with the at least one provided or modified immersive educational content, wherein the at least one robotic device comprises or is in communication with the at least one processor;
retrieve anonymized learner data associated with a user interacting with the at least one provided immersive educational content; or
provide, via at least one robot output device of the at least one robotic device, an interactive learning interface associated with the at least one provided immersive educational content based on the retrieved anonymized learner data.

12. The autonomous education system of claim 1, comprising:
at least one Internet-Of-Things (IoT) resource in communication with the at least one user device, and configured to:
determine the at least one session event and provide the at least one determined session event to the at least one user device, wherein the at least one user device is configured to provide the at least one determined session event received from the at least one IoT resource to the server,
and the server is configured to:
adaptively modify the at least one generated immersive educational content corresponding to the at least one educational session based on the at least one determined session event, and
provide the at least one modified immersive educational content to the at least one user device, the at least one output device, or a combination thereof.

13. The autonomous education system of claim 1, wherein the at least one user device, the at least one input device, or a combination thereof is configured to determine real-time environmental data, behavioral data, emotional data, biometric data, or any combination thereof associated with a user interacting with the at least one provided immersive educational content during the at least one educational session, and the at least one determined session event corresponds to:
a change in determined real-time environmental data, behavioral data, emotional data, biometric data, or any combination thereof associated with the user during the at least one educational session;
at least one user input or user-initiated change, via the at least one input device, corresponding the at least one provided or modified immersive educational content;
at least one annotation received corresponding to the at least one provided or modified immersive educational content via the at least one input device; or
any combination thereof.

14. The autonomous education system of claim 1, wherein the education delivery sequence comprises a hierarchy of educational elements based on the at least one predefined educational framework, and wherein the server is configured to generate the at least one immersive educational content corresponding to at least one educational element of the educational elements in the education delivery sequence based on the determined context, and further wherein the at least one user device is configured to determine the education delivery sequence based on the at least one immersive educational content provided corresponding to an educational element of the educational elements prior to the commencement of a current educational session of the at least one educational session, or based on at least one input received corresponding to the educational element via the at least one input device.

15. The autonomous education system of claim 1, wherein the at least one user device comprises the at least one input device and the at least one output device, and wherein the at least one user device corresponds to a plurality of user devices each comprising the at least one input device and the at least one output device respectively, and wherein the server is configured to:
detect the commencement of the at least one educational session on a first user device of the plurality of user devices;
register a second user device of the plurality of user devices corresponding to the at least one commenced educational session, wherein the second user device is configured to request connection to the at least one commenced educational session in the first user device via a network;
determine the context associated with the at least one commenced educational session via the first and the second user device; and
synchronize, in real-time, the at least one provided immersive educational content on the at least one output device associated with the first and second user device respectively based on the determined context.

16. The autonomous education system of claim 15, wherein the server is configured to:
assign each user device of the plurality of user devices a priority for providing the at least one generated or modified immersive educational content or for receiving at least one input via the at least one input device associated with the corresponding user device;
determine the at least one session event via the at least one input device associated with each user device;
merge the at least one determined session event corresponding to each user device;
determine at least one overlap or conflict between the at least one determined session event corresponding to each user device; and
synchronize, in real-time, the at least one modified immersive educational content on each user device based on the at least one merged session event and the at least one determined overlap or conflict.

17. The autonomous education system of claim 16, wherein the server is configured to resolve the at least one determined overlap or conflict by at least one of:
selecting the at least one determined session event corresponding to a user device of the plurality of user devices received last from among the plurality of user devices via the at least one input device;
selecting the at least one determined session event based on the priority assigned to each user device; or
providing user confirmation prompts, via the at least one output device, corresponding to the at least one determined session event.

18. The autonomous education system of claim 1, wherein the at least one user device is configured to:
track a progress of the determined education delivery sequence based on the at least one played or modified immersive educational content during each educational session, an assessment test provided during the at least one educational session, or a combination thereof;
modify the determined context in response to the at least one determined session event based on the tracking; and
provide the modified context to the server,
wherein the server is configured to:
modify the at least one generated immersive educational content based on the modified context; and
provide the at least one modified immersive educational content to the at least one user device.

19. The autonomous education system of claim 1, wherein the at least one provided or modified immersive educational content comprises an interactive two-dimensional (2D) or three-dimensional (3D) avatar, wherein the at least one processor is configured to modify, in real-time, a response, a tone, an animation, a presentation style, or any combination thereof of the interactive 2D or 3D avatar, based on the at least one determined session event.

20. The autonomous education system of claim 1, wherein the modified presentation style corresponds to offering motivational support or at least one recommendation, adjusting a pacing or difficulty level of the at least one provided immersive educational content, suggesting a break, or any combination thereof.

21. The autonomous education system of claim 1, wherein a difficulty level of the at least one modified immersive educational content is lesser or greater in comparison to the at least one previously provided immersive educational content.

22. The autonomous education system of claim 1, wherein the at least one generated immersive educational content comprises at least one spatially localized auditory output provided to the at least one output device such that a sound associated with the at least one spatially localized auditory output is perceived by a user at one or more predefined positions within a three-dimensional (3D) environment surrounding the user based on the determined context associated with the 3D environment, a behavior or reaction of the user to the sound, a configuration of the at least on user device, or any combination thereof.

23. An electronic device for providing autonomous education, comprising:
a processor; and
a memory for storing instructions and at least one user device artificial intelligence (AI) model, that when executed by the processor, causes the electronic device to:
commence, via the processor, at least one educational session,
determine, via at least one input device, a learner profile and a context associated with each educational session of the at least one educational session,
determine, via the processor, at least one educational framework associated with the determined context and the determined learner profile,
determine, via the processor, an education delivery sequence corresponding to the at least one determined educational framework and the determined context,
generate, via the processor, at least one immersive educational content associated with the determined context based on the determined education delivery sequence for the at least one educational session, and
provide the at least one generated immersive educational content,
wherein the electronic device is configured to:
determine, via the at least one input device and the processor, at least one session event corresponding to the at least one provided immersive educational content during the at least one commenced educational session,
modify, via the processor, the at least one generated immersive educational content based on the at least one determined session event, and
provided the at least one modified immersive educational content by adaptively modifying the at least one provided immersive educational content during the at least one commenced educational session.

24. A method for providing autonomous education, comprising:
commencing, via at least one user device, at least one educational session;
determining, via the at least one user device, a learner profile and a context associated with each educational session of the at least one educational session;
determining, via the at least one user device, at least one educational framework associated with the determined context;
determining, via the at least one user device, an education delivery sequence corresponding to the at least one determined educational framework and the determined context;
providing, by the at least one user device, the determined context, the determined learner profile, the determined education delivery sequence to a server;
generating, via the server, at least one immersive educational content associated with the determined context based on the determined education delivery sequence for the at least one educational session;
providing, by the server, the at least one generated immersive educational content to the at least one user device corresponding to the at least one commenced educational session;
determining, via at least one input device, the at least one user device, or a combination thereof, at least one session event during the at least one educational session;
providing, by the at least one user device, the at least one determined session event to the server;
adaptively modifying, by the server, the at least one generated immersive educational content based on the at least one determined session event;
providing, by the server, the at least one modified immersive educational content to the at least one user device; and
providing, via the at least one user device, the at least one modified immersive educational content.

25. The method of claim 24, comprising:
gamifying, via the server, the at least one generated immersive educational content,
providing, by the server, the at least one gamified immersive educational content to the at least one user device;
tracking, via the at least one user device, a user performance corresponding to the at least one gamified immersive educational content; and
providing, by the at least one user device, at least one performance indication, a reward, or a combination thereof based on and associated with the tracked user performance.

26. The method of claim 24, comprising:
generating, by the server, at least one assessment test associated with the at least one provided immersive educational content corresponding to the at least one educational session, or the at least one educational session corresponding to a plurality of educational sessions;
providing, by the server, the at least one generated assessment test to the at least one user device;
recording, via the at least one user device, a user performance corresponding to the at least one provided assessment test; and
providing, by the at least one user device, the recorded user performance to the server.

27. The method of claim 26, comprising:
verifying, via the server, a compliance of the at least one provided assessment test, the recorded user performance, or a combination thereof with the at least one determined educational framework;
updating, by the server, the learner profile based on verification and the recorded user performance; and
storing, by the server, at least one timestamped record of the updated learner profile, the recorded user performance, or a combination thereof in at least one blockchain ledger.

28. The method of claim 24, comprising authenticating, via the server, a user and the at least one user device operated by the user prior to the commencement of the at least one educational session, wherein the at least one user device is in communication with the server.

29. The method of claim 28, comprising:
storing, via the server, at least one educational record or credential associated with the user, wherein the authentication of the user is based on the at least one stored educational record or credential.

30. The method of claim 29, comprising:
determining, via the at least one user device, a connectivity to a network during or prior to the commencement of the at least one educational session;
queuing, by the at least one user device, at least one action associated with the learner profile or the credential associated with the user when the determined connectivity is indicative of an unavailability of the network; and
initiating, by the at least one user device, the at least one action when the determined connectivity is indicative of an availability of the network.

31. The method of claim 24, comprising at least one of:
providing, via at least one robotic device, at least one physical gesture associated with the at least one provided immersive educational content, wherein the at least one robotic device is in communication with the server;
retrieving, via the at least one robotic device, anonymized learner data associated with a user interacting with the at least one provided immersive educational content; or
providing, via at least one robot output device of the at least one robotic device, an interactive learning interface associated with the at least one provided immersive educational content based on the retrieved anonymized learner data.

32. An autonomous education system, comprising:
at least one input device;
at least one output device;
at least one user device communicatively coupled with the at least one input device and the at least one output device, the at least one user device is configured to commence at least one educational session; and
a server in communication with the at least one user device, wherein the at least one user device, the server, or both the at least user device and the server in combination are configured to:
determine, via the at least one input device, a learner profile and a context associated with each educational session of the at least one educational session,
determine at least one educational framework associated with the determined context and the determined learner profile,
determine an education delivery sequence corresponding to the at least one determined educational framework and the determined context, and
generate at least one immersive educational content associated with the determined context based on the determined education delivery sequence for the at least one educational session, and
provide the at least one generated immersive educational content to the at least one output device, and
wherein the at least one output device is configured to:
provide the at least one immersive educational content received from the server corresponding to the at least one commenced educational session,
and further wherein the at least one input device is configured to:
determine at least one session event during the at least one commenced educational session, and
provide the at least one determined session event to the at least one user device, the server, or both the at least user device and the server, wherein the at least one user device, the server, or both the at least user device and the server are configured to modify the at least one generated immersive educational content based on the at least one determined session event and provide the at least one modified immersive educational content to the at least output device, and the at least one output device is configured to adaptively modify the at least one provided immersive educational content based on one or more device-specific configurations associated with the at least one output device and provide the at least one modified immersive educational content during the at least one commenced educational session.
